(19) United States
(12) Patent Application Publication
(10) Pub. No.: US 2026/0235250 A1
(43) Pub. Date: Aug. 13, 2026

(54) PIPE SUPPORT BLOCK, EXTENSION BLOCK, AND PIPE SUPPORT ASSEMBLY

(71) Applicant: Evolution Mechanical Products, LLC, Ridgefield, CT (US)

(72) Inventor: Michael S. Flynn, Ridgefield, CT (US)

(21) Appl. No.: 19/537,847

(22) Filed: Feb. 12, 2026

Related U.S. Application Data
(60) Provisional application No. 63/757,596, filed on Feb. 12, 2025.

(51) Int. Cl. F16L 59/13; F16L 59/135

(52) U.S. Cl. CPC F16L 59/13; F16L 59/135

(57) ABSTRACT

A support block in accordance with an embodiment of the present disclosure includes: a top support surface spanning a first area incorporating a plurality of troughs; and a bottom side spanning a second area, wherein the second area is larger than the first area wherein at least one of the plurality of troughs is formed by a plurality of angled surfaces, and wherein the top support surface incorporates one or more top side openings, said one or more top side openings sized and positioned to receive corresponding one or more bottom side extensions of an extension block. In embodiments a system to support a pipe may include one or more support blocks.

### CROSS-REFERENCE TO RELATED APPLICATIONS

The present application claims benefit of and priority to U.S. Provisional Patent Application Ser. No. 63/757,596 filed Feb. 12, 2025 entitled PIPE SUPPORT BLOCK, EXTENSION BLOCK, AND PIPE SUPPORT ASSEMBLY, the entire content of which is hereby incorporated by reference herein.

### BACKGROUND

### Field of Disclosure

The present disclosure generally relates to installations involving insulated pipes and, more specifically, to a pipe support block and a pipe support assembly that is usable for supporting a pipe while installing insulation thereto.

### Related Art

For pipes in and around a building, insulation is often required, for example, for cold water/refrigerated water pipes to prevent condensation on the pipes. Insulation is usually installed, when needed, after all pipes have been installed. For indoor pipes, pipe supports ordinarily hang from the ceiling of the building and include hanger support rods and a horizontal curved member that is in direct contact with the pipe. Such horizontal support members directly contact the surface of the pipes and, therefore, do not allow room for placing insulation around the pipes. Consequently, the process can involve various combinations of trying to lower the horizontal support member, bending the supports and/or shifting the pipe, and/or completely replacing supports with new support that are correctly positioned to accommodate the thickness of the insulation. This can greatly increase the time and difficulty associated with applying insulation to the pipes.

These and other issues are recognized and addressed by U.S. Pat. No. 10,627,040 (the '040 Patent) filed May 14, 2019 for Michael S. Flynn and issued on Apr. 21, 2020, the entirety of which is hereby incorporated by reference. The '040 Patent describes a flexible standoff for supporting a pipe while installing insulation thereto.

### SUMMARY

The present disclosure is directed to an improved support block and support block assembly to support a pipe while installing insulation.

A support block in accordance with an embodiment of the present disclosure includes: a top support surface spanning a first area incorporating a plurality of troughs; and a bottom side spanning a second area, wherein the second area is larger than the first area, wherein at least one of the plurality of troughs is formed by a plurality of angled surfaces, and wherein the top support surface incorporates one or more top side openings, said one or more top side openings sized and positioned to receive corresponding one or more bottom side extensions of an extension block.

In embodiments, a ratio of a depth of the at least one trough and a height of the support block is a first ratio.

In embodiments, the at least one trough has a first depth.

In embodiments, a ratio of the depth of the at least one trough and a depth of another one of the plurality of troughs is a first value.

In embodiments, the plurality of angled surfaces are angled relative to horizontal.

In embodiments, the support block includes a plurality of fastener elements adapted to engage a corresponding plurality of fasteners of the extension block.

In embodiments the plurality of fastener elements are disposed on respective side walls on opposing sides of the support block.

In embodiments, the plurality of fastener elements are disposed at about ⅓ and ⅔ of a total length from respective ends of the support block.

In embodiments, the support block includes the extension block placed atop the top support surface by at least partially inserting the one or more bottom side extensions of the extension block into the one or more top side openings of the support block, wherein the plurality of fasteners of the extension block are engaged with the plurality of fastener elements of the support block.

In embodiments, the support block includes an additional extension block placed atop a top surface of the extension block.

In embodiments, the extension block incorporates a top surface having substantially the same contours as the top support surface.

In embodiments, the extension block incorporates bottom side contours that correspond to contours of the top support surface.

A support block assembly in accordance with another embodiment of the present disclosure includes a plurality of support blocks according to claim 1 formed as a unitary structure with the plural support blocks connected to one another in a lengthwise parallel arrangement by a respective resilient connector.

In embodiments, the respective resilient connector incorporates a plurality of grooves that each define a living hinge arranged parallel to respective lengths of the plurality of support blocks.

An extension block in accordance with another embodiment of the present disclosure includes: a top support surface incorporating a plurality of troughs; and a bottom side incorporating one or more extensions sized and positioned to be at least partially inserted to one or more top side openings on a support block, wherein at least one of the plurality of troughs is formed by a plurality of angled surfaces, and wherein the top support surface incorporates one or more top side openings, said one or more top side openings sized and positioned to receive the one or extensions of an additional extension block.

In embodiments, the extension block includes a plurality of fastener elements adapted to engage a corresponding plurality of fasteners of the additional extension block.

A support block assembly in accordance with an embodiment of the present disclosure includes: a plurality of support blocks, each of the plurality of support blocks including a first top support surface spanning a first area and incorporating one or more first top side openings; and a first bottom side spanning a second area; one or more resilient connectors extending between the plurality of support blocks in a lengthwise parallel direction and defining a unitary structure; and one or more extension blocks placed atop a corresponding one or more of the plurality of support blocks, each of said one or more extension blocks including: a second top support surface incorporating one or more second top side openings; and a second bottom side incorporating one or more extensions sized and positioned to be at least partially inserted to the one or more first top side openings of the corresponding one or more of the plurality of support blocks, wherein the second area is larger than the first area.

In embodiments, the first top support surface and the second top support surface have substantially the same contours, and the second bottom side incorporates contours that correspond to contours of the first top support surface.

In embodiments, the one or more resilient connectors incorporate a plurality of grooves that each define a living hinge arranged parallel to respective lengths of the plurality of support blocks.

In embodiments, the plurality of support blocks comprise, on the first bottom side, a plurality of notches at respective ends of respective lengths of the plurality of support blocks and at respective outer sides of the plurality of support blocks away from another of the plurality of support blocks.

A support block for supporting a pipe in accordance with an embodiment of the present disclosure includes: an elongated base; a top surface including depressions extending longitudinally and transversely; a top surface having a first width; a bottom portion having a second width, the second width larger than the first width; and the base made of a flexible material.

In embodiments, at least one opening is formed in a top surface configured to receive a portion of an extension block configured for mounting on the support block.

In embodiments, the support block includes a pair of openings formed on a top surface configured to receive portions of an extension block configured for mounting on the support block.

In embodiments, wherein the block includes a fastening element positioned on a sidewall of the elongated base and configured to interact with an extension block configured for mounting on the support block.

In embodiments, the block includes at least one hinge connected to a sidewall of the base, wherein the hinge is connectable to a second support block such that the second support block is rotatable relative to the support block.

In embodiments, the at least one hinge is a living hinge.

In embodiments, the at least one hinge is a first hinge of a pair of hinges connecting the support block to the second support block.

In embodiments, the support block includes a first hinge connected to a first sidewall of the base, wherein the first hinge is connectable to a second support block such that the second support block is rotatable relative to the support block and a second hinge connected to a second sidewall of the base, wherein the second hinge is connectable to a third support block such that the third support block is rotatable relative to the support block.

In embodiments, the first hinge is a living hinge and the second hinge is a living hinge.

In embodiments, the first hinge is one of a pair of hinges connecting the support block to the second support block and the second hinge is one of a second pair of hingers connecting the support block to the third support block.

A support block assembly configured to support a pipe in accordance with an embodiment of the present disclosure includes: a first support block rotatably connected to a second support block and a third support block rotatable connected to the second support block, wherein each of the first support block, the second support block and the third support block includes: an elongated base; a top surface including depressions extending longitudinally and transversely; a top surface having a first width; a bottom portion having a second width, the second width larger than the first width; and the base made of a flexible material.

In embodiments, the block assembly includes an extension block configured for mounting on one of the first support block, the second support block and the third support block.

In embodiments, the extension block comprises at least one protrusion extending from a bottom portion thereof and configured to interact with at least one of the first support block, the second support block and the third support block.

In embodiments, each of the first support block, the second support block and the third support block includes at least one opening formed in a top surface thereof and configured to receive the at least one protrusion of the extension block.

In embodiments, wherein the extension block includes a fastener extending from a sidewall of the extension block and below a bottom portion thereof to contact one of the support block, the second support block and the third support block to secure the extension block to a respective one of the support block, the second support block and the third support block.

In embodiments, each of the support block, the second support block and the third support block includes a fastener element positioned on a sidewall thereof to interact with the fastener of the extension block to secure the extension block to one of the support block, the second support block and the third support block.

In embodiments, the support block is secured to the second support block via a first hinge such that the second support block is rotatable relative to the support block and the support block is secured to the third support block via a second hinge such that the third support block is rotatable relative to the support block.

In embodiments, the first hinge and the second hinge are living hinges.

In embodiments, the first hinge is one of a first pair of hinges and the second hinge is one of a second pair of hinges.

In embodiments, the support block, the second support block and the third support block each include a pair of notches formed at a bottom edge thereof to aid in flexing of the base.

### BRIEF DESCRIPTION OF THE DRAWINGS

Various example implementations of this disclosure will be described in detail, with reference to the following figures, wherein:

FIG. 1A is a schematic diagram of a temporary standoff in the related art supporting a pipe in a pipe support.

FIG. 1B is a perspective view of the temporary standoff of FIG. 1A.

FIG. 2A is a schematic diagram showing a top perspective view of a support block assembly in accordance with an embodiment of the present disclosure.

FIG. 2B is a schematic diagram showing a bottom perspective view of the support block assembly of FIG. 2A in accordance with an embodiment of the present disclosure.

FIG. 2C is a schematic diagram showing a top plan view of the support block assembly of FIG. 2A in accordance with an embodiment of the present disclosure.

FIG. 3A is a schematic diagram showing a cross-sectional side view across a line marked 3A-3A in FIG. 2C in accordance with an embodiment of the present disclosure.

FIG. 3B is a schematic diagram showing a cross-sectional side view across a line marked 3B-3B in FIG. 2C in accordance with an embodiment of the present disclosure.

FIG. 3C is a schematic diagram showing a side view of a support block across a line marked 3C-3C in FIG. 2C in accordance with an embodiment of the present disclosure.

FIG. 4A is a schematic diagram showing a top perspective view of an extension block that is adapted to be fittingly coupled to a top side of a support block of the support block assembly of FIG. 2A in accordance with an embodiment of the present disclosure.

FIG. 4B is a schematic diagram showing a bottom perspective view of the extension block of FIG. 4A in accordance with an embodiment of the present disclosure.

FIG. 4C is a schematic diagram showing a perspective view of extension block of FIG. 4A coupled to the support block assembly of FIG. 2A in accordance with an embodiment of the present disclosure.

FIG. 5 is a schematic drawing showing a perspective view of the support block assembly of FIG. 2A provided in a curved orientation;

FIG. 6 illustrates a schematic drawing showing an end view of the perspective view of the support block assembly of FIG. 2A provided in a curved orientation with an extension block;

FIG. 7 is a schematic diagram showing an end view of two extension blocks of FIG. 4A coupled to the support block assembly of FIG. 2A in accordance with an embodiment of the present disclosure.

FIG. 8 is a schematic diagram showing an end view of multiple extension blocks of FIG. 4A coupled to multiple support blocks of the block assembly of FIG. 2A in accordance with an embodiment of the present disclosure.

FIG. 9 is a schematic diagram showing an end view of multiple extension blocks of FIG. 4A coupled to each of multiple support blocks of the block assembly of FIG. 2A in accordance with an embodiment of the present disclosure.

FIG. 10A illustrates an end view of the block assembly of FIG. 2A provided in a rectangular orientation in accordance with an embodiment of the present disclosure.

FIG. 10B illustrates a perspective view of the block assembly of FIG. 2A provided in a rectangular orientation in accordance with an embodiment of the present disclosure.

FIG. 11A illustrates a perspective view of a support block in accordance with an embodiment of the present disclosure.

FIG. 11B illustrates an end view of the support block of FIG. 11A in accordance with an embodiment of the present disclosure.

FIG. 11C illustrates a perspective view of a support block assembly utilizing the support block of FIG. 11A in accordance with an embodiment of the present disclosure.

FIG. 11D illustrates a cross section of the support block assembly of FIG. 11C in accordance with an embodiment of the present disclosure.

FIG. 12A illustrates a perspective view of a support block in accordance with an embodiment of the present disclosure.

FIG. 12B illustrates an end view of the support block of FIG. 12A in accordance with an embodiment of the present disclosure.

FIG. 12C illustrates a perspective view of a support block assembly utilizing the support block of FIG. 12A in accordance with an embodiment of the present disclosure.

FIG. 12D illustrates a cross section of the support block assembly of FIG. 12C in accordance with an embodiment of the present disclosure.

FIG. 13A illustrates a perspective view of a support block assembly in accordance with an embodiment of the present disclosure.

FIG. 13B illustrates an end view of the support block assembly of FIG. 13A in accordance with an embodiment of the present disclosure.

FIG. 13C illustrates a perspective view of an extension block for use with the support block assembly of FIG. 13B in accordance with an embodiment of the present disclosure.

FIG. 13D illustrates an end view of the extension block illustrated in FIG. 13C in accordance with an embodiment of the present disclosure.

FIG. 14A illustrates a perspective view of an extension block in accordance with another embodiment of the present disclosure.

FIG. 14B illustrates a top view of the extension block of FIG. 14A in accordance with an embodiment of the present disclosure.

FIG. 14C illustrates an end view of the extension block of FIG. 14A in accordance with an embodiment of the present disclosure.

FIG. 14D illustrates a side view of the extension block of FIG. 14A in accordance with an embodiment of the present disclosure.

FIG. 14E illustrates a bottom view of the extension block of FIG. 14A in accordance with an embodiment of the present disclosure.

FIG. 14F illustrates a bottom perspective view of the extension block of FIG. 14A in accordance with an embodiment of the present disclosure.

FIG. 14G illustrates a top view of the extension block of FIG. 14A with lines B-B illustrated thereon, in accordance with an embodiment of the present disclosure.

FIG. 14H illustrates a cross-section of the extension block of FIG. 14G along the line B-B in accordance with an embodiment of the present disclosure.

FIG. 14I illustrates a side view of the extension block of FIG. 14A with line A-A illustrated thereon, in accordance with an embodiment of the present disclosure.

FIG. 14J illustrates a cross-section of the extension block of FIG. 14I along the line A-A in accordance with an embodiment of the present disclosure.

FIG. 15A illustrates a perspective view of a support block assembly flexed in accordance with an embodiment of the present disclosure.

FIG. 15B illustrates a top view of the support block assembly in FIG. 15A an embodiment of the present disclosure.

FIG. 15C illustrates an end view of the support block assembly in FIG. 15A in accordance with an embodiment of the present disclosure.

FIG. 15D illustrates a side view of the support block assembly in FIG. 15A an embodiment of the present disclosure.

FIG. 16A illustrates a perspective view of the support block assembly of FIG. 15A connected to a bracket in accordance with an embodiment of the present disclosure..

FIG. 16B illustrates a top view of the support block assembly of FIG. 15A connected to a bracket in accordance with an embodiment of the present disclosure.

FIG. 16C illustrates an end view of the support block assembly of FIG. 15A connected to a bracket. in accordance with an embodiment of the present disclosure.

FIG. 16D illustrates a side view of the support block assembly of FIG. 15A connected to a bracket in accordance with an embodiment of the present disclosure..

FIG. 17A illustrates the perspective view of the support block assembly of FIG. 16A on a bracket supporting a transverse pipe in accordance with an embodiment of the present disclosure.

FIG. 17B illustrates a top view of the support block assembly of FIG. 16A on a bracket supporting a transverse pipe in accordance with an embodiment of the present disclosure.

FIG. 17C illustrates an end view of the support block assembly of FIG. 16A on a bracket supporting a transverse pipe in accordance with an embodiment of the present disclosure.

FIG. 17D illustrates a side view of the support block assembly of FIG. 16A on a bracket supporting a transverse pipe in accordance with an embodiment of the present disclosure.

FIG. 18A illustrates a perspective view of a support block assembly in accordance with an embodiment of the present disclosure.

FIG. 18B illustrates a top view of the support block assembly in FIG. 18A an embodiment of the present disclosure.

FIG. 18C illustrates an end view of the support block assembly in FIG. 18A in accordance with an embodiment of the present disclosure.

FIG. 18D illustrates a side view of the support block assembly in FIG. 18A an embodiment of the present disclosure.

FIG. 18E illustrates a bottom view of the support block assembly of FIG. 18A in accordance with an embodiment of the present disclosure.

FIG. 18F illustrates a bottom perspective view of the support block assembly of FIG. 18A in accordance with an embodiment of the present disclosure.

FIG. 19A illustrates a perspective view of a support block assembly including a single extension block in accordance with an embodiment of the present disclosure.

FIG. 19B illustrates a top view of the support block assembly in FIG. 19A an embodiment of the present disclosure.

FIG. 19C illustrates an end view of the support block assembly in FIG. 19A in accordance with an embodiment of the present disclosure.

FIG. 19D illustrates a side view of the support block assembly in FIG. 19A an embodiment of the present disclosure.

FIG. 19E illustrates a bottom view of the support block assembly in FIG. 19A an embodiment of the present disclosure.

FIG. 19F illustrates a bottom perspective view of the support block assembly in FIG. 19A an embodiment of the present disclosure.

FIG. 20A illustrates a perspective view of a support block assembly including two stacked extension blocks in accordance with an embodiment of the present disclosure.

FIG. 20B illustrates a top view of the grouping of the support block assembly in FIG. 20A an embodiment of the present disclosure.

FIG. 20C illustrates an end view of the support block assembly in FIG. 20A in accordance with an embodiment of the present disclosure.

FIG. 20D illustrates a side view of the support block assembly in FIG. 20A an embodiment of the present disclosure.

FIG. 20E illustrates a bottom view of the support block assembly in FIG. 20A an embodiment of the present disclosure.

FIG. 20F illustrates a bottom perspective view of the support block assembly in FIG. 20A an embodiment of the present disclosure.

FIG. 21 illustrates an end view of a support block assembly including two stacked extension blocks on either side of the assembly in accordance with an embodiment of the present disclosure.

FIG. 22 illustrates an end view of a support block assembly including three stacked extension blocks in accordance with an embodiment of the present disclosure.

FIG. 23A illustrates a top perspective view of a support block assembly mounted in a supporting panel to support a pipe in accordance with an embodiment of the present disclosure.

FIG. 23B illustrates a bottom perspective view of a support block assembly mounted in a supporting panel to support a pipe in accordance with an embodiment of the present disclosure.

FIG. 23C illustrates an end view of the support block assembly mounted in a supporting panel to support a pipe in accordance with an embodiment of the present disclosure.

FIG. 23D illustrates a side end view of the support block assembly mounted in a supporting panel to support a pipe in accordance with an embodiment of the present disclosure.

### DETAILED DESCRIPTION

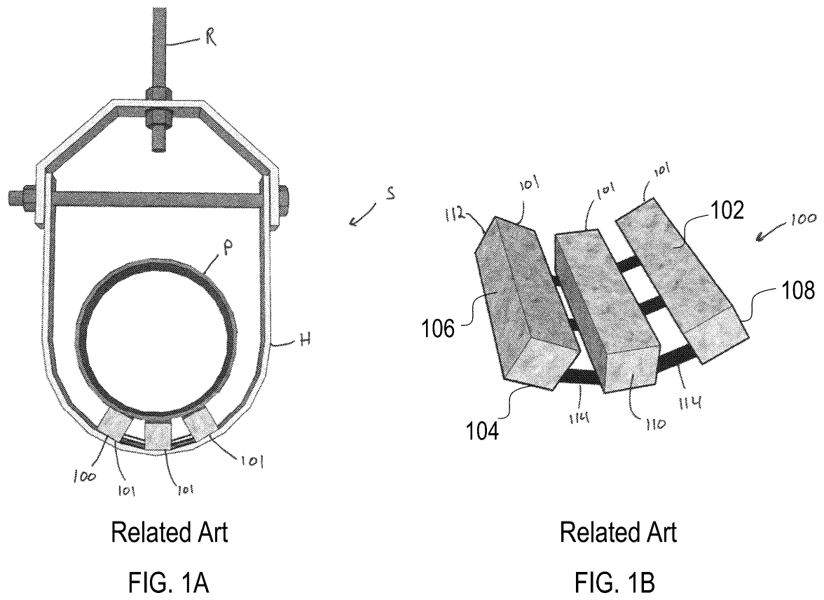

FIGS. 1A and 1B illustrate an example of the temporary standoff 100 described in U.S. Pat. No. 10,627,040 which is placed between a pipe P and a pipe support S. The pipe support S includes a hanger rod R and a horizontal curved member H. The standoff 100 has a plurality of blocks 101. Each block 101 has a top surface 102, a bottom surface 104, first and second sides 106, 108, a front surface 110, and a rear surface 112. As illustrated in FIGS. 1A and 1B, surfaces 102, 104, 106, 108, 110, and 112 are substantially flat and form right angles with one another to form a cuboid block 101.

As shown in FIG. 1B, the blocks 101 are spaced from each other and are connected by flexible connectors 114, which permit the interconnected blocks to assume a curved profile by bending with respect to each other, and facilitate installation of a set of blocks.

With the standoff 100 assuming a shape that corresponds to the pipe P, the weight of the pipe P can be distributed over a larger surface area (as opposed to a round pipe resting on a singular flat-shaped surface). As shown in FIG. 1A, the pipe P is positioned in place and the support rod R of the pipe support S is attached to the surrounding structure. The horizontal curved member H is placed underneath the pipe P with the support rod R supporting the horizontal curved member H. The temporary standoff 100 is disposed between the pipe P and the horizontal member H. The horizontal member H can be raised underneath the pipe P until the pipe P is contacted by the standoff 100 with the flexible connections 114 flexing such that the blocks 101 at least partially surround the pipe P. Once the horizontal member H is in position such that the pipe is supported by the temporary standoff 100, the horizontal member H can be fixed to the support rod R (e.g., with nuts attached to threaded ends of the support rods). As such, the pipe P is supported and spaced via the temporary standoff 100 until insulation can be installed about the pipe. During the insulation installation process, the temporary standoff 100 is removed from between the pipe P and the horizontal member H and insulation is provided about the pipe P with a portion of the insulation being disposed between the pipe P and the horizontal member H in a space that was previously occupied by the temporary standoff 100.

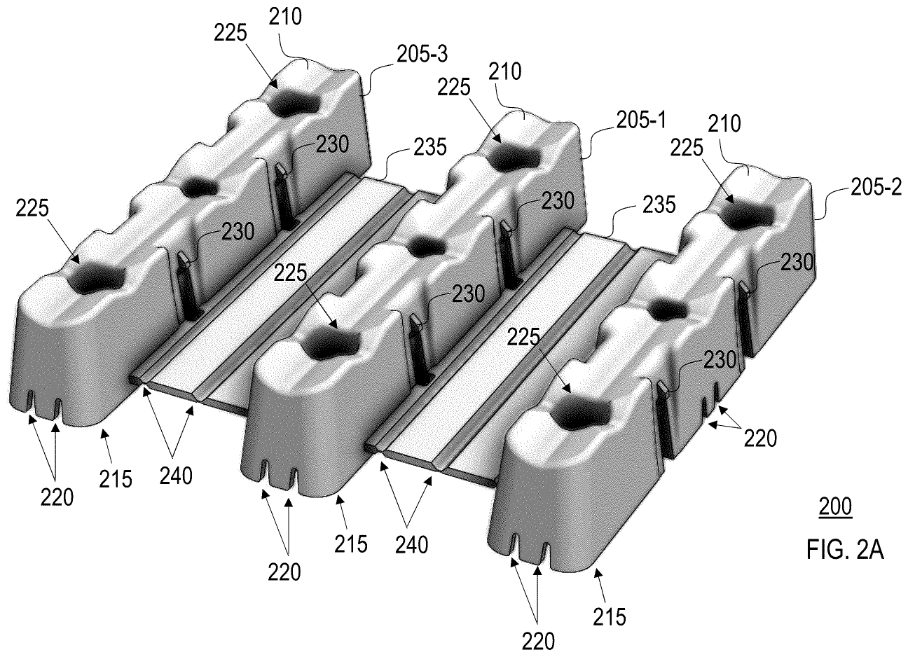

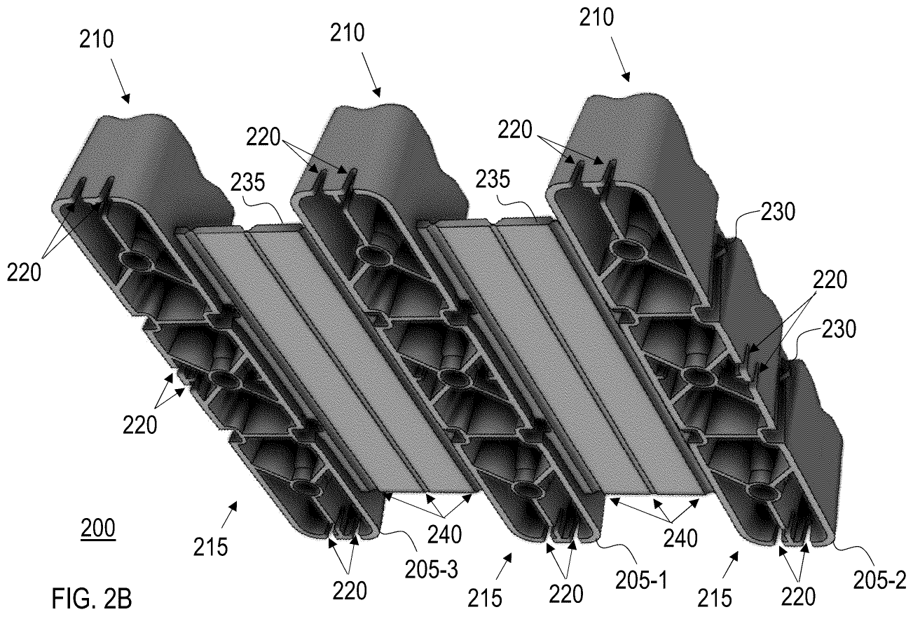

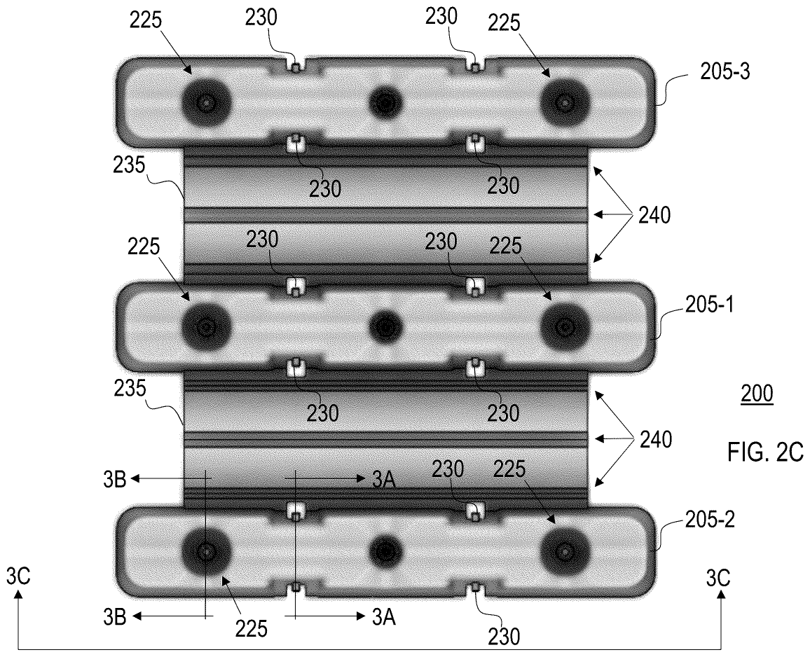

FIG. 2A is a top perspective view of a support block assembly 200 in accordance with an embodiment of the present disclosure. FIG. 2B is a bottom perspective view of the block assembly 200 and FIG. 2C is a top plan view of the block assembly 200. In accordance with one or more exemplary embodiments, the support block 205 is a rigid or semi-rigid material, such as a polymer composite, fiber glass, or the like—that is adapted to provide a secure support structure for holding up a pipe. In embodiments, any suitable rigid or semi-rigid material may be used in the block assembly 205.

As shown in FIGS. 2A, 2B, and 2C, the support block assembly 200 includes a plurality of elongate support blocks 205-1, 205-2, and 205-3. In embodiments, the block assembly 200 may include a different number of support blocks 205-x (x≥1). Each support block 205 may have an elongate shape. In embodiments, each support block 205 incorporates a shape that approximates a trapezoidal prism, or trapezium, with a top support surface 210 that is smaller than a bottom portion 215 across one or both dimensions of block 205. Advantageously, in embodiments, the larger bottom 215 of each block 205 contributes to its stability during deployment so that block 205 does not easily rotate onto its side when, for example, it is placed between pipe (P) and a horizontal member H. In embodiments, each block 205 is identical in shape and dimension. In embodiments, one or more blocks 205 in the block assembly 200 may have different dimensions—for example, center block 205-1 may be slightly larger than side blocks 205-2 and 205-3, or vice versa. In embodiments, the block 205 may be made of a high impact polypropylene or any other suitable material that supports loads up to 5000 PSI. The blocks 205 are sturdy and reusable.

In embodiments, top support surface 210 incorporates one or more concave elements that are adapted to contact and corresponding one or more sections of a cylindrical outer surface of one or more pipes (e.g., pipe P in FIG. 1).

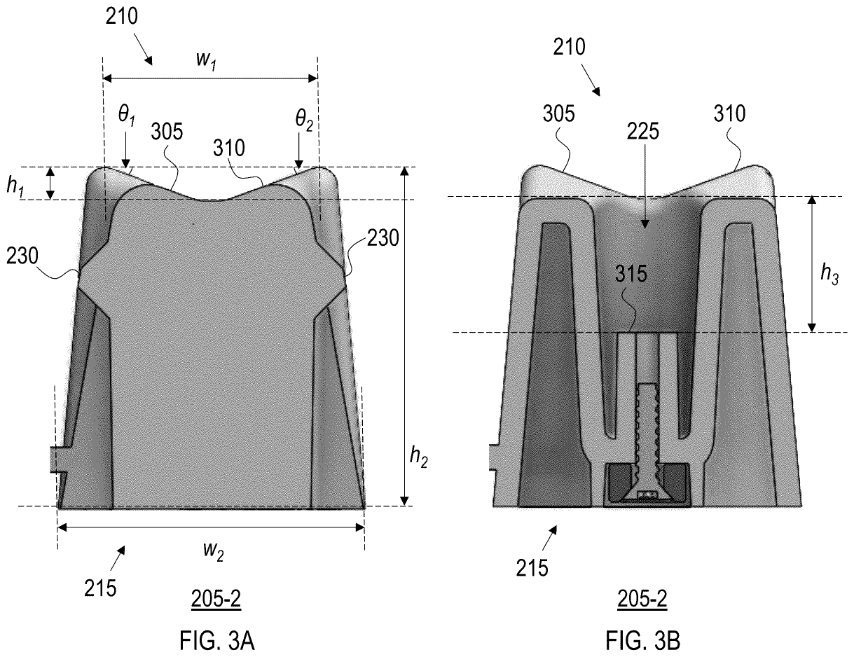

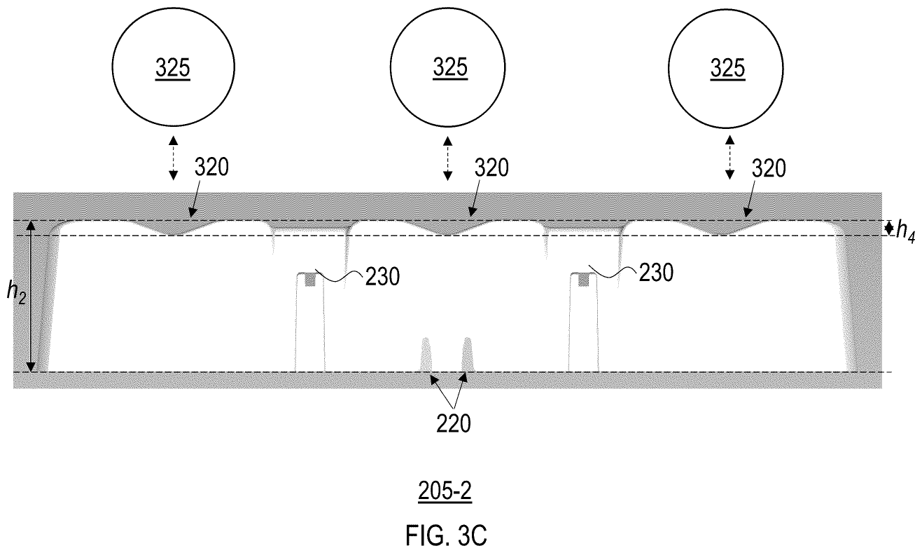

FIG. 3A is a cross-sectional view of block 205-2 at line 3A-3A in FIG. 2C and FIG. 3B is a cross-sectional view of block 205-2 at line 3B-3B in FIG. 2C.

As illustrated in FIGS. 2, 3A and 3B, each block 205 may include incurvations on the top support surface 210 along the lengths thereof. FIGS. 3A and 3B show block 205-2 which is representative of the blocks 205. As shown in FIGS. 3A and 3B, the lengthwise incurvation on the top surface 210 of each block 205 is formed by two opposing angled surfaces 305 and 310 that extend along the length of block 205. In embodiments, each the angled surfaces 305 and 310 is angled with respect to horizontal (angles θ₁ and θ₂ in FIG. 3A) such that a V shape with a height (h₁) is formed between the side peaks and the center bottom of the V shape, thereby approximating an arc that corresponds to an exterior surface of a pipe P. In embodiments, the angles of the surfaces may vary and the height h₁ provided that a suitable V shape is provided. As shown in FIG. 3A, each block 205 incorporates a top support surface 210 with a peak-to-peak width (w₁) in the V shape, which defines an approximate contact width of top support surface 210 on the pipe P. The width w₁ may also vary provided that a desired V shape is provided. Accordingly, in embodiments, the angled surfaces 305 and 310 form V-shaped troughs along the lengths of blocks 205. In embodiments, the angled surfaces 305 and 310 are adapted to contact a cylindrical pipe, such as the pipe P in FIG. 1A, from respective sides to provide support. In embodiments, the troughs may be other shapes including U-shaped for example. In embodiments, the angled surfaces 305 and 310 restrict roll and slide movements between a pipe (e.g., pipe P in FIG. 1A) and blocks 205. Advantageously, in embodiments, the blocks 205 and/or the block assembly 200 provides a stable interface between a top surface 210 and the pipe (e.g., pipe P in FIG. 1A). In embodiments, FIGS. 3A and 3B illustrate symmetrical angled surfaces 305 and 310 (e.g., having substantially the same widths and equal angles θ₁ and θ₂) but surfaces 305 and 310 may have different angles from horizontal (different angles θ₁ and θ₂ in FIG. 3A) and/or different widths across the block 205 to form the asymmetrical top support surface 210. In embodiments, the block 205 may also incorporate different depth-to-width ratios, for example, h₁-w₁ ratios, for supporting different pipes.

In embodiments, each block 205 may have a height (h₂) of about 2.5 cm. In embodiments the height (h₂) may be varies to accommodate the thickness of insulation that is to be applied to a pipe (e.g., pipe P in FIG. 1A). In embodiments, a desired ratio between the height of the incurvation (h₁) on the top support surface 210 to the overall height of block 205 (h₂) may be maintained. In certain embodiments, the height (h₂) may be made larger or smaller based on the insulation to be installed to a pipe and, correspondingly, the h₁:h₂ ratio can be made larger or smaller.

In embodiments, each block 205 incorporates tapered side walls so that the bottom 215 is larger than the upper support surfaces 210. Each block 205, therefore, has a wider base than top side. Each block 205 incorporates a top support surface 210 with a peak-to-peak width (w₁), which defines an approximate contact width of the top support surface 210 on the pipe. The bottom side width (w₂) of the bottom side 215 may have a desired value as well. In embodiments, top support surface 210 is a first length and the bottom side 215 has a second length. The larger bottom side 215 of each block 205 contributes to its stability during deployment so that block 205 does not easily rotate when, for example, it is placed between a pipe (P) and a horizontal member (H) as illustrated in FIG. 1.

Referring back to FIGS. 2A and 2B, each support block 205 incorporates one or more notches, or indents, 220 along the perimeter of the outer bottom edge of the bottom side 215. As illustrated in FIG. 2B, the notches 220 are cut into the side walls of each block 205. Each of the blocks 205-1, 205-2, and 205-3 incorporates pairs of notches 220 at the bottom edge at the ends of their respective lengths. Blocks 205-2 and 205-3 further incorporate pairs of notches 220 at the bottom edges of both their inward and outward sidewalls. In embodiments, each block 205 includes pairs of notches 220 at bottom edges on all sides thereof. In embodiments, the notches 220 provide for flexibility of the bottom edges of each block 205 so that bottom sides 215 can flex to contact a curved support surface of a horizontal member of a pipe support. In certain embodiments, a horizontal member may incorporate bumps (not shown) that engage notches 220 so as to hold blocks 205 in place while supporting a pipe, thereby further improving the stability of the interface formed by the block assembly 200, including the blocks 205 thereof between the pipe support (not shown) and the pipe (e.g., pipe P in FIG. 1A). In embodiments, the blocks 205 provide for improved stability of support.

In embodiments, the notches 220 may have a desired width and height and are preferably spaced apart when in the paired arrangement. In certain embodiments, additional or fewer notches 220 may be provided. In embodiments, the notched 220 may be provided at different locations and may be provide in different arrangements.

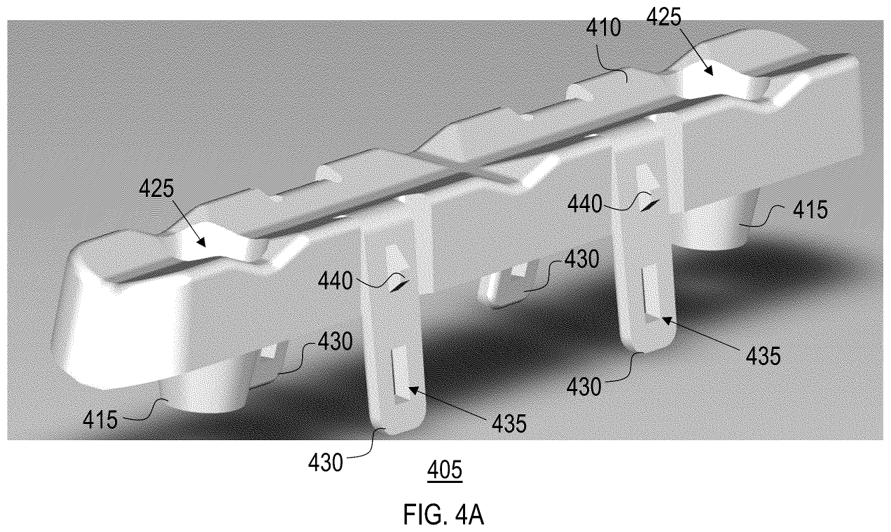

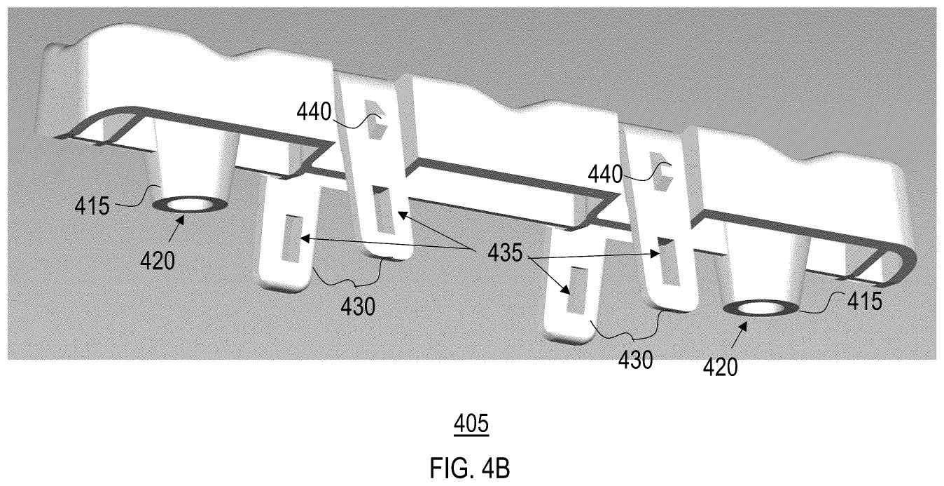

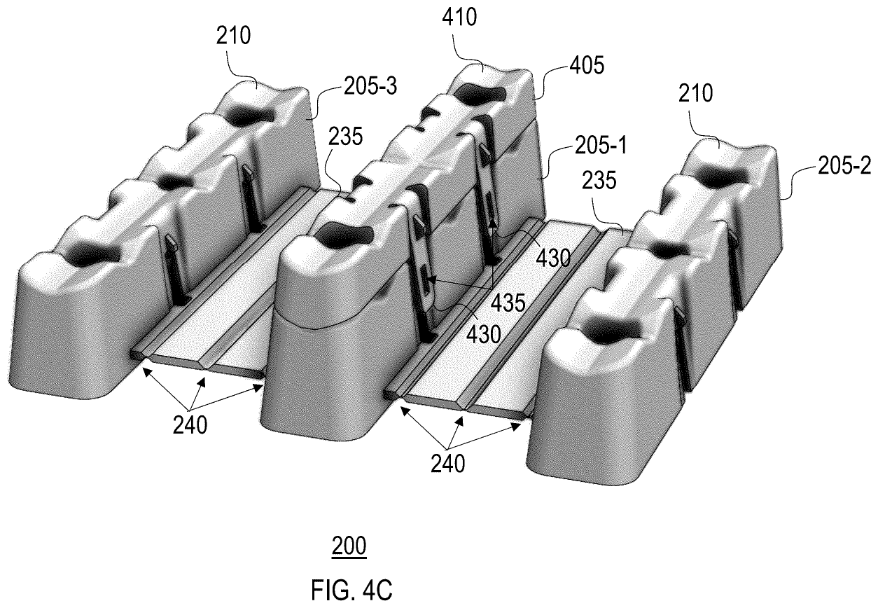

In embodiments, FIG. 3B shows a cross-sectional view of the block 205 showing a top opening 225 provided in the top surface 210. In embodiments, the top opening 225 extends downward to an interior platform 315. In embodiments, a depth of the top opening 225 from the top surface 210 to the interior platform 315 (h₃) is a desired value. Each block 205 incorporates a pair of top openings 225 formed in the top surface 210 at respective ends thereof. In embodiments, the top openings 225 are sized and positioned for connection with an extension block. In embodiments, the openings 225 may receive extensions 415 (see FIGS. 4A and 4B, for example) extending from extension block 405 (see FIGS. 4A and 4B, for example) to extend the height of block 205. In embodiments, block 205 may include additional or fewer top openings 225 for fittingly coupling with extension block 405 via a corresponding number of extensions 415 on extension block 405.

In embodiments, the top support surface 210 of each block 205 also incorporates a series of incurvations that extend across the widths thereof. FIG. 3C is a side view of block 205-2 at line 3C-3C in FIG. 2C. As shown in FIG. 3C, in embodiments, top support surface 210 of each block 205 incorporates plural incurvations, or troughs, 320 that extend across the width of block 205. In embodiments, troughs 320 may extend in a direction that is orthogonal to the trough formed by angled surfaces 305 and 310. In embodiments, troughs 320 may include angled surfaces and have a similar V-shaped profile formed by angled surfaces 305 and 310. In embodiments, the troughs 320 have a depth, or a height (h₄) between the side peaks and the center bottom of the V shape. In embodiments, the ratio between the height of the troughs, 320 (h₄) on the top support surface 210 to the overall height of block 205 (h₂) may be set as desired. In certain embodiments, the height (h₂) may be increased or decreased based on the insulation to be installed on the pipe. In embodiments, the h₄:h₂ ratio may be adjusted. In embodiments, the respective depths of troughs 320 and the trough formed by angled surfaces 305 and 310 have a h₄:h₁ ratio. FIG. 3C shows three pipes 325 for illustrating a deployment of block 205 or assembly 200 to support such pipes 325 using troughs 320 in an arrangement that is orthogonal to the deployment of standoff 100 in relation to pipe P shown in FIG. 1A. For the support arrangement illustrated in FIG. 3C, block 205 and/or assembly 200 can be supported by a flat horizontal member of a pipe support, or the like.

FIG. 4A is a top perspective view of an extension block 405 in accordance with an embodiment of the present disclosure, that is adapted to be fittingly coupled to a top side of support block 205. FIG. 4B is a bottom perspective view thereof and FIG. 4C is a perspective view of extension block 405 coupled to block 205-1 of assembly 200. In embodiments, extension block 405 may be made of the same material as support block 205.

In embodiments, as can be seen in FIGS. 4A and 4C, extension block 405 incorporates a top support surface 410 that is substantially the same, in size, shape, and/or contours, as top support surface 210 of each support block 205, including top openings 425 that correspond to top openings 225. As shown in FIG. 4B, in embodiments, extension block 405 incorporates two downward extensions 415 that correspond, in size and shape, to top openings 225 on top support surface 210 of blocks 205. Extension block 405 further incorporates contours around extensions 415 that correspond to the contours of top surface 210 of support blocks 205 (or top support surface 410 of another extension block 405) so that extension block 405 is fitted atop top support surface 410 of support block 205 (or another extension block 405) when bottom side extensions 415 are at least partially inserted into top side openings 225 (or top side openings 425). According to one or more exemplary embodiments, bottom side extensions 415 incorporate openings 420 that are dimensioned to receive interior platform 315 (FIG. 3B) for a fitted coupling, where the friction between the side walls of bottom side extensions 415 and the interior walls of top side openings 225 holds extension block 405 to support block 205. In certain embodiments, releasable mating notches, ridges, rims, or the like, can be incorporated to the interior of top side openings 225 and bottom side extensions 415 for a releasable engagement that holds blocks 205 and 405 together.

As further illustrated in FIGS. 4A and 4B, extension block 405 incorporates fasteners 430 that are adapted to engage corresponding fastener elements 230 on blocks 205, which are shown in FIGS. 2A-3A and 3C. According to one or more exemplary embodiments, fasteners 430 are resilient (e.g., rubber) tabs that incorporate openings 435 for hooking onto fastener elements 230 that are in the form of angled protrusions, or anchors, on respective side walls on opposing sides of blocks 205. Thus, extension block 405 can be releasably fastened to block 205 when the height (h₂) of block 205 needs to be extended for supporting a pipe. FIG. 4C illustrates extension block 405 fastened to block 205-1 of assembly 200. Extension block 405 can be formed to have any height, including up to the height (h₂) of block 205. According to one or more exemplary embodiments, extension block 405 extends the height (h₂) of block 205. According to one or more exemplary embodiments of the present disclosure, fastener elements 230 and fasteners 430 are disposed on both sides of blocks 205 and block 405, respectively, at positions that are about ⅓ and ⅔ of the total lengths from the ends of blocks 205 and 405. Thus, as illustrated in the figures, blocks 205 and 405 each incorporate two pairs of fastener elements 230 and fasteners 430, respectively, that are disposed at positions that divide the length of the block 205 or 405 into thirds. Advantageously, the number and positions of the fasteners provide for a strong attachment between support block 205 and extension block 405, while providing for an ease of releasing each of the fasteners. In certain embodiments, different numbers and/or types of fasteners can be used for releasably attaching extension block 405 to support block 205. In embodiments, the positioning of the fasteners may be modified as well.

As further illustrated in FIGS. 4A and 4B, extension block 405 incorporates fastener elements 440, such as angled protrusions or anchors, that are positioned to allow for fasteners 430 of a second extension block 405 to be fastened atop a first extension block 405. In other words, more than one extension block 405 can be stacked atop a support block 205 by fastening fasteners 430 of a first extension block 405 to fastener elements 230 of a support block, fastening fasteners 430 of a second extension block 405 to fastener elements 440 of the first extension block 405, and so on. Thus, blocks 205 and/or assembly 200, with extension blocks 405, provide flexibility for supporting pipes of various diameters and corresponding insulation of various thicknesses. For example, one or more blocks 205 can be adjusted using extension block 405 to a height that is equal to or exceeds the thickness of the insulation of a pipe by a small amount, such as 2% or less. The uniformity of blocks 205 provides for reduced manufacturing costs, while different numbers of extension blocks 405 can be used to provide flexibility for fittingly supporting pipes of various sizes and with insulation of various thicknesses. According to one or more exemplary embodiments of the present disclosure, extension block 405 extends the height (h₂) of top support surface 210 of support blocks 205 so that a total height to a corresponding peak (not shown) on top support surface 410 from bottom side 215 of support block 205 is set as desired. In certain embodiments, extension blocks 405 may be provided with different heights for different height adjustments.

Referring back to FIGS. 2A, 2B, and 2C, in embodiments, assembly 200 incorporates connectors 235 provided between blocks 205. According to one or more exemplary embodiments, each connector 235 incorporates a unitary structure that extends along the lengths of blocks 205 that it connects, with one or more (e.g., three) grooves 240 that are parallel to the lengths of blocks 205. In embodiments, the connectors 235 prevent rotation among blocks 205 around their lateral axes to maintain a parallel arrangement of the blocks 205. In embodiments, this simplifies installation of the assembly 200. According to one or more exemplary embodiments, connectors 235 may be made of a resilient and/or a semi-rigid material, such as a polymer composite or the like. In embodiments, the grooves 240 define a living hinge between adjacent blocks 205 for supporting a curved exterior surface of a pipe while, restricting rotation around their lateral axes. In embodiments, flexing of the connectors 235 provides a curved profile with a radius that approximates that radius of a pipe, such as pipe P in FIG. 1A. When pipe P rests on assembly 200, pipe P can be seated securely on blocks 205.

In certain embodiments, a single support block 205 may be used as a temporary support or, alternatively, any number of support blocks 205 can be connected to one another via connectors 235 for use as a support block assembly 200.

### EXAMPLES

### Example 1

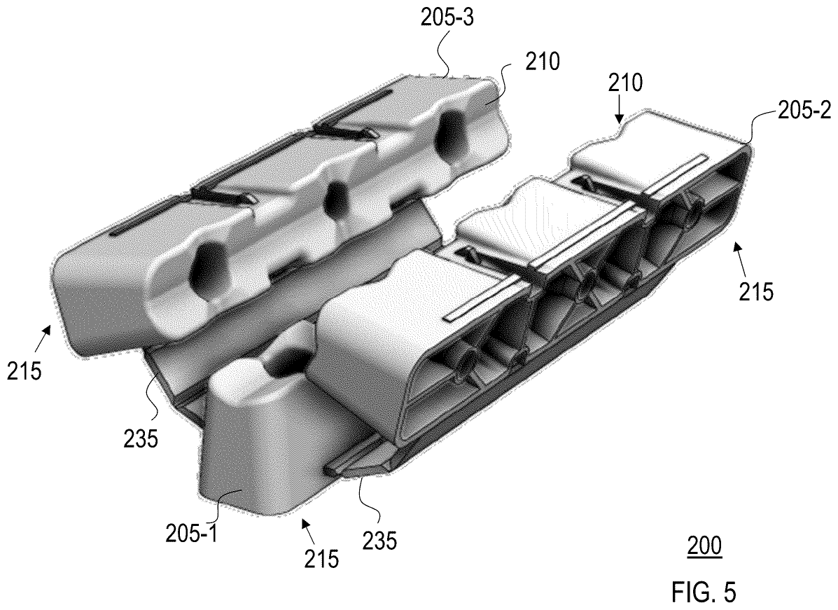

FIG. 5 is a perspective view illustrating assembly 200 for supporting a pipe of a first diameter range. As illustrated in FIG. 5, blocks 205-2 and 205-3 are disposed upward in relation to block 205-1 and are rotated inward to support the respective sides of a pipe. In this deployment arrangement, a horizontal member (not shown) may support the bottom sides 215 of blocks 205. The horizontal member may have a curved surface that corresponds to the configuration of blocks 205. In embodiments, connectors 235 tend to maintain blocks 205 in a parallel relationship with one another while allowing for rotating blocks 205-2 and 205-3 around a longitudinal axis of block 205-1. Additionally, as noted before, the tapered shapes of blocks 205 reduce the possibility of blocks 205 rolling onto their sides and the top support surfaces 210 of blocks 205 increase the stability of interfaces with a pipe.

### Example 2

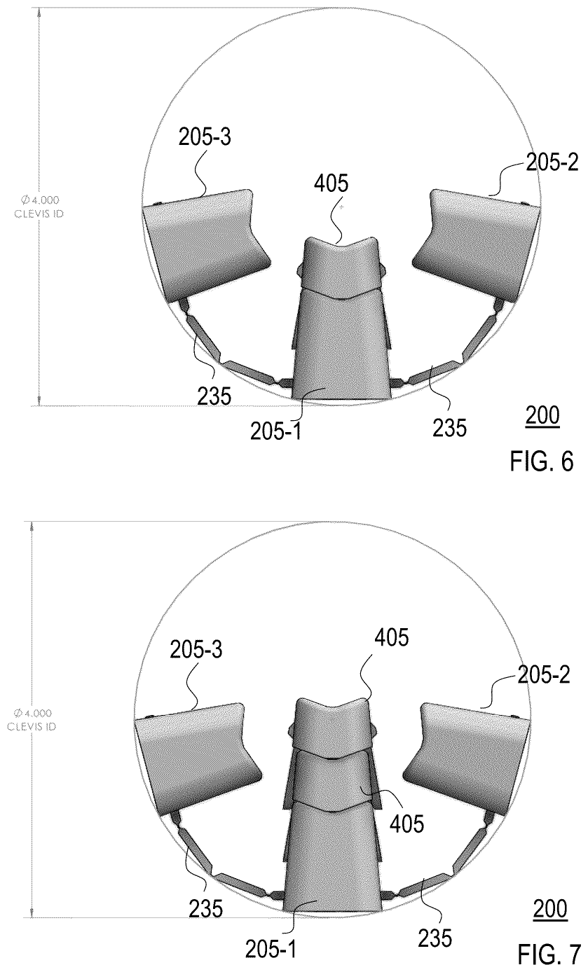

FIG. 6 is a front side view illustrating assembly 200 with one extension block 405 attached to block 205-1 in the manner described above in connection with FIGS. 4A-4C. As illustrated in FIG. 6, blocks 205-2 and 205-3 can be rotated upward and inward in relation to a longitudinal axis of block 205-1 and the configuration illustrated in FIG. 6 can be used to support a pipe of a second diameter range.

### Example 3

FIG. 7 is a front view illustrating assembly 200 with two extension blocks 405 attached on top of block 205-1 in the manner described above in connection with FIGS. 4A-4C. As illustrated in FIG. 7, blocks 205-2 and 205-3 can be rotated upward and inward in relation to a longitudinal axis of block 205-1 and the configuration illustrated in FIG. 7 can be used to support a pipe that is in a third diameter range.

### Example 4

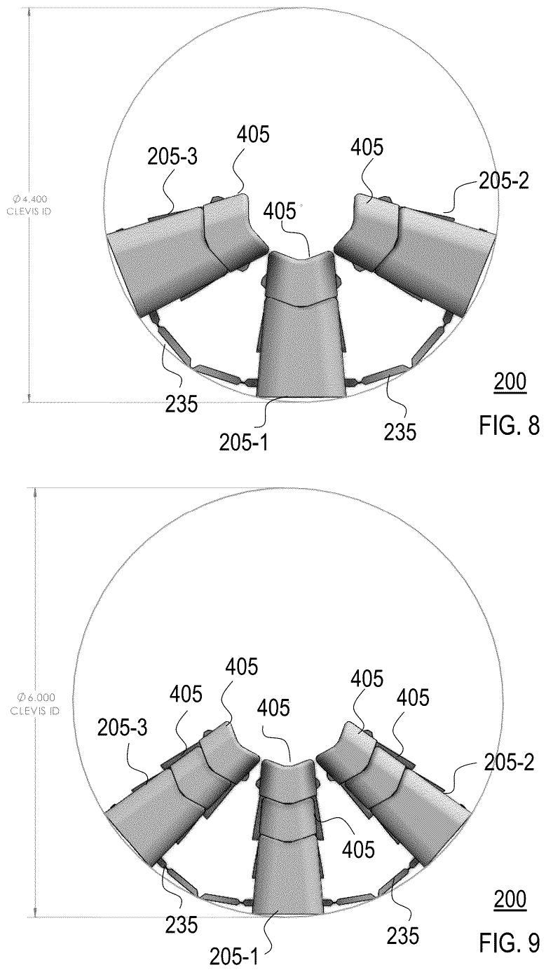

FIG. 8 is a front side view illustrating assembly 200 with one extension block 405 attached on top of each of blocks 205-1, 205-2, and 205-3 in the manner described above in connection with FIGS. 4A-4C. As illustrated in FIG. 8, blocks 205-2 and 205-3, with respective extension blocks 405, can be rotated upward and inward in relation to a longitudinal axis of block 205-1 and the configuration illustrated in FIG. 8 can be used to support a pipe that is in a fourth diameter range.

### Example 5

FIG. 9 is a front side view illustrating assembly 200 with two extension blocks 405 attached on top of each of blocks 205-1, 205-2, and 205-3 in the manner described above in connection with FIGS. 4A-4C. As illustrated in FIG. 8, blocks 205-2 and 205-3, with respective two extension blocks 405, can be rotated upward and inward in relation to a longitudinal axis of block 205-1 and the configuration illustrated in FIG. 9 can be used to support a pipe that is in a fifth diameter range.

### Example 6

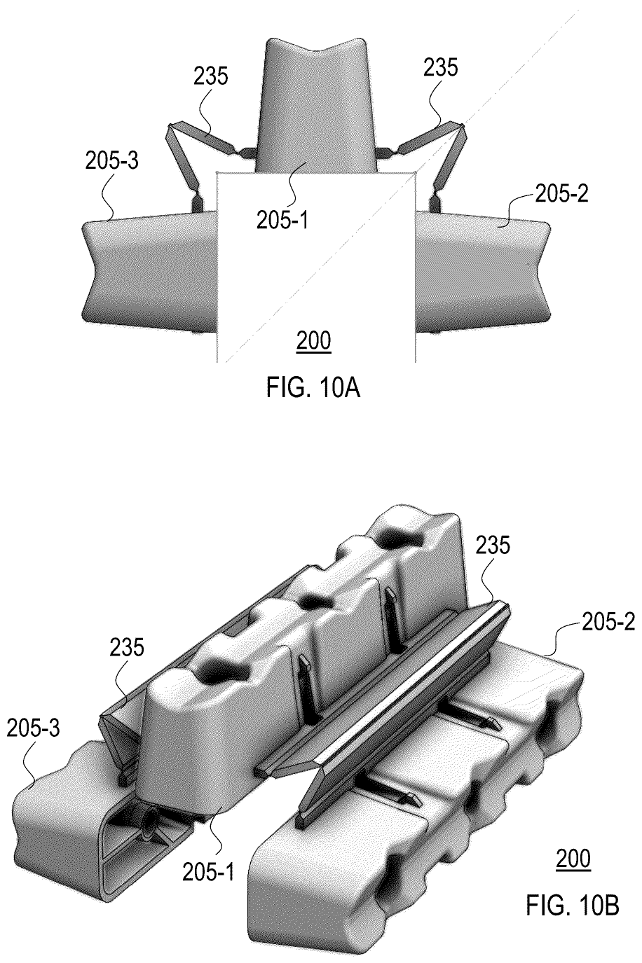

FIG. 10A is a front side view illustrating assembly 200 in an alternative configuration. FIG. 10B is a perspective view corresponding to FIG. 10A. As illustrated in FIGS. 10A and 10B, blocks 205-2 and 205-3 in embodiments, are rotated downward and outward in relation to a longitudinal axis of block 205-1. In this configuration, blocks 205-1, 205-2, and 205-5 can be supported by respective sides of a square bar, square tube, or the like (not shown), rather than a curved support. As an example, the square bar/tube (not shown) can have sides that are about 4.13 cm (or 1.625 inches), or 4 to 4.25 cm, wide. Block 205-1 can provide bottom support for one pipe and blocks 205-2 and 205-3 can provide side support for respective additional pipes. In this configuration, assembly 200 can be used to provide at least partial support to up to three (3) pipes that are in a set diameter range.

### Example 7

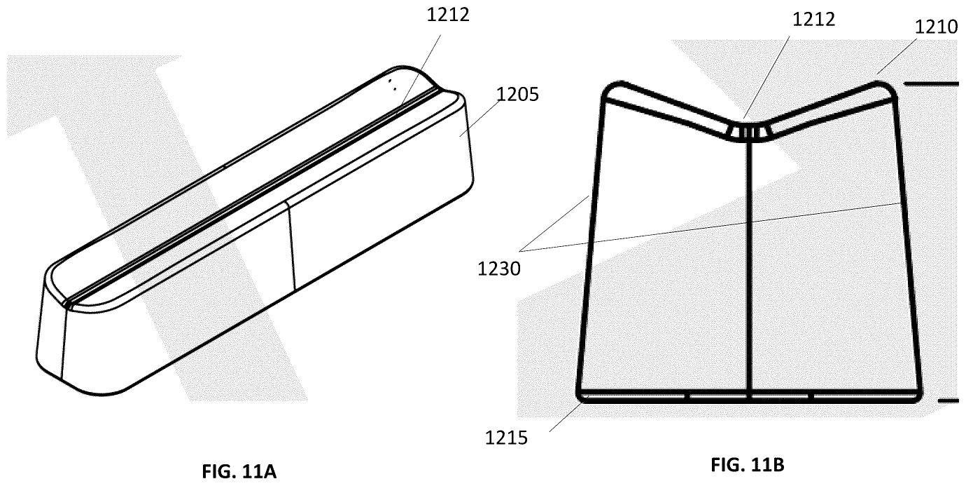

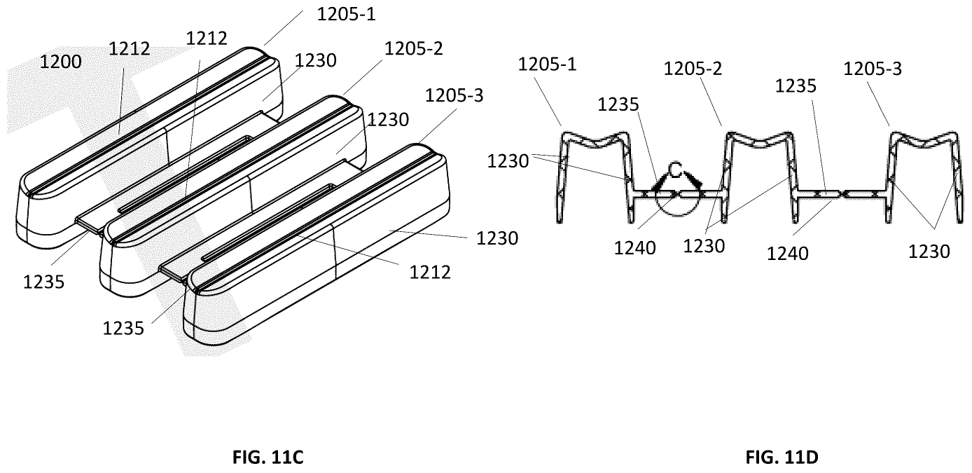

FIGS. 11A and 11B illustrate an alternative support block 1205. In embodiments, each block 1205 may include a top surface 1210 and a wider bottom 1215. In embodiments, the top surface 1210 may include a slot 1212 formed in a center portion thereof extending substantially the length of the block 1205. In embodiments, the slot 1212 extends downward such that the top surface 1210 has a general V-shape. In embodiments, the V-shaped slot 1212 may accommodate the cylindrical pipe P. In embodiments, other shapes may accommodate the pipe P, for example, U-shaped. In embodiments, the sidewalls 1230 of each block 1205 are tapered such that the top surface 1210 is narrower than the bottom portion 1215. In embodiments, the sidewall 1230 extends downward from the top surface on the sides and at each longitudinal end of the block 1205 while the bottom is substantially open such that the wide bottom 1215 refers to the distance between the sidewalls 1230 at the bottom of the block 1205.

In embodiments, as illustrated in FIGS. 11C-11D, support block assembly 1200 may include multiple support blocks 1205-1, 1205-2 and 1205-3, for example. In embodiments, the support blocks 1205-1, 1205-2, 1205-3 may be connected using connectors 1235. In embodiments, the connectors 1235 may be made of a flexible and resilient material which allows the blocks 1205-1, 1205-2 and 1205-3 to rotate relative to each other and provide an overall curved shape for the assembly 1200. In embodiments, like connectors 235 discussed above, the connectors 1235 also prevent rotation among blocks 205 around their lateral axes to maintain a parallel arrangement. In embodiments, the connectors 1235 may include one or more living hinges 1240 to facilitate flexing of the connectors 1235 to allow movement of the blocks 1205-1, 1205-2 and 1205-3 relative to each other.

### Example 8

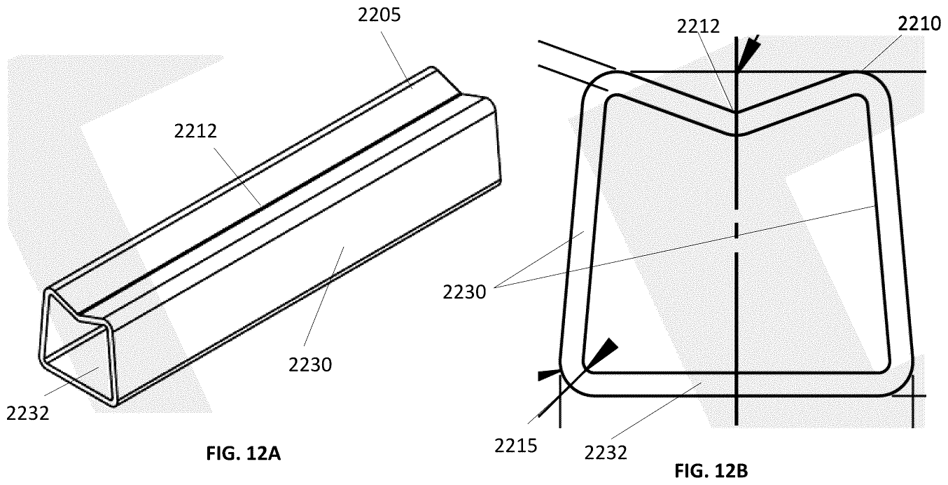

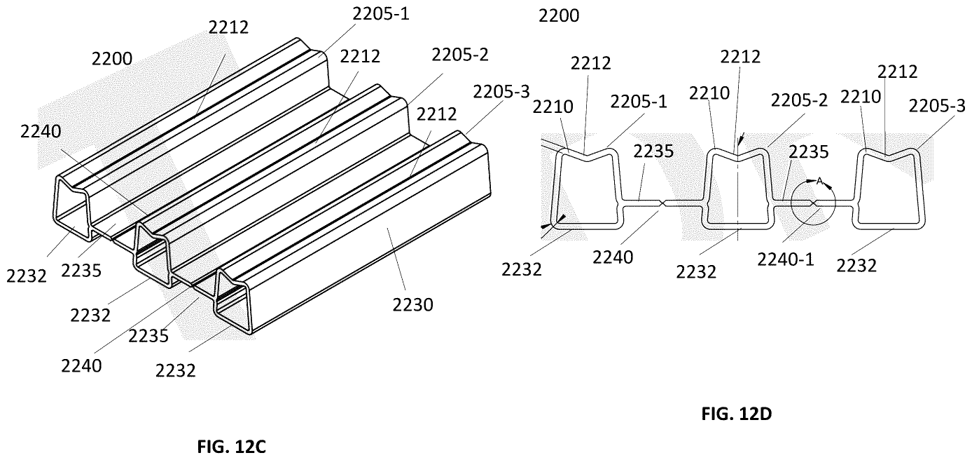

FIGS. 12A and 12B illustrate an alternative support block 2205. In embodiments, each support block 2205 may include a top surface 1210 and a wider bottom surface 2215. In embodiments, the top surface 1210 may include a slot 2212 formed in a center portion thereof extending substantially the length of the block 1205. In embodiments, the slot 2212 extends downward such that the top surface 2210 has a general V-shape. In embodiments, the V-shaped slot 2212 may accommodate the cylindrical pipe P. In embodiments, other shapes such as U-shaped may accommodate the pipe P. In embodiments, the sidewalls 2230 of each block 2205 are tapered such that the top surface 1210 is narrower than the bottom surface 1215. In embodiments, the sidewall 1230 extends downward from the top surface on the sides and at each longitudinal end of the block 1205 and the bottom surface 2232 connects the sidewalls 2230. Including a horizontal bottom surface 2232 provides for improved strength and stability of the block 2205.

In embodiments, as illustrated in FIGS. 12C-12D, support block assembly 2200 may include multiple support blocks 2205-1, 2205-2 and 2205-3, for example. In embodiments, the blocks 2205-1, 2205-2, 2205-3 may be connected using connectors 2235. In embodiments, the connectors 2235 may be made of a flexible and resilient material which allows the blocks 2205-1, 2205-2 and 2205-3 to rotate relative to each other and provide an overall curved shape for the assembly 1200. In embodiments, like connectors 235 discussed above, the connectors 2235 also prevent rotation among blocks 2205 around their lateral axes to maintain a parallel arrangement. In embodiments, the connectors 2235 may include one or more living hinges 2240 to facilitate flexing of the connectors 2235 to allow movement of the blocks 2205-1, 2205-2 and 2205-3 relative to each other.

### Example 9

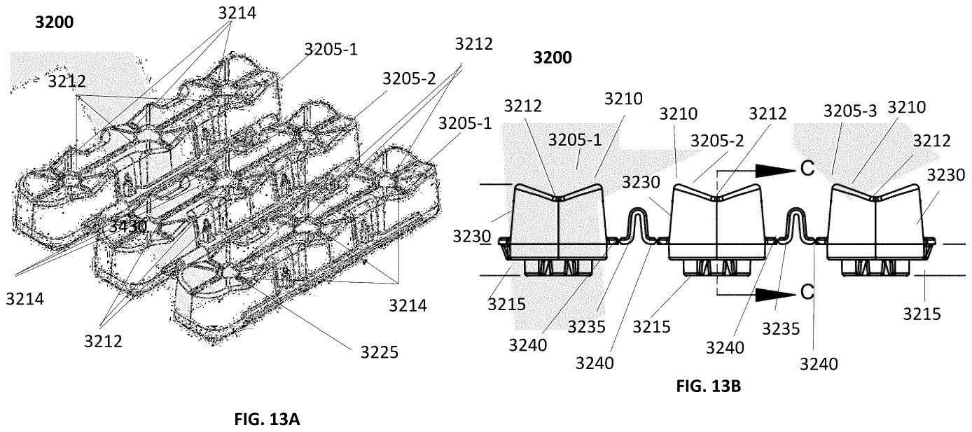

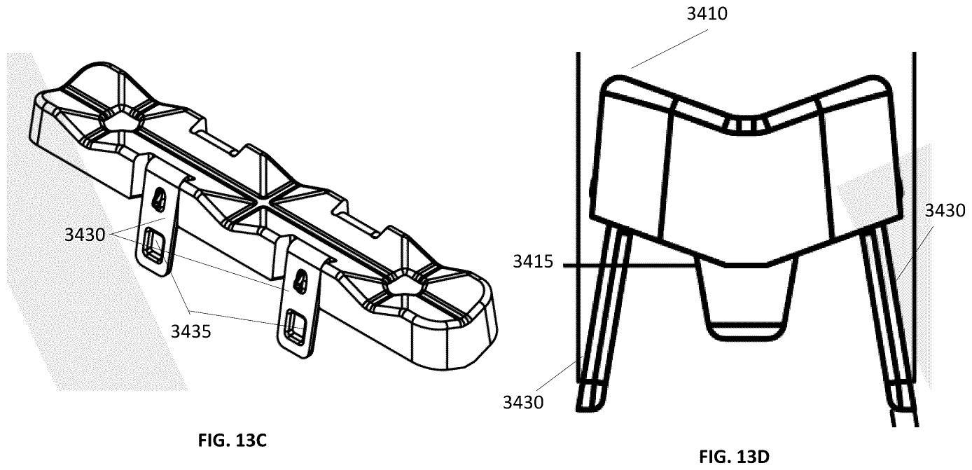

FIGS. 13A and 13B illustrate a support block assembly 3200 including support blocks 3205-1, 3205-2, 3205-3. In embodiments, each support block 3205 may include a top surface 3210 and a wider bottom portion 3215. In embodiments, the top surface 3210 may include one or more curved portions 3212 formed in a center portion thereof such that a longitudinal slot 3212 extends downward and forms a V-shaped slot along the longitude of the top surface 3210. In embodiments, the curved portions 3212 provide for transverse troughs 3214 which extend transverse to the longitudinal axis of the block 3205. In embodiments, the combination of the V-shaped slot 3212 in combination with the transverse troughs 3214 may accommodate the cylindrical pipe P when the block 3205 supports the pipe P. As noted above, other shapes may support the pipe P, for example, U-shaped. In embodiments, the sidewalls 3230 of each block 3205 are tapered such that the top surface 3210 is narrower than the bottom portion 3215. In embodiments, the sidewall 3230 extends downward from the top surface on the sides and at each longitudinal end of the block 3205 and the bottom is substantially open. In embodiments, connectors 3235 may be provided between the blocks 3205-1, 3205-2, 3205-3 which may operate in substantially the same manner as the connectors 235 discussed above. In embodiments, the connectors 3235 may include one or more living hinges 3240 to allow of movement of the blocks 3205-1, 3205-2, 3205-3 relative to each other

In embodiments, FIGS. 13C and 13D illustrate an exemplary extension block 3405 that may be mounted on the one or more of the support blocks 3205-1, 3205-2, 3205-3. In embodiments, the extension block 3405 includes fasteners 3430 which may be mad of a resilient material and include incorporate openings 3435 that may connect to the sidewall 3230 of the blocks 3205-1, 3205-2, 3205-3. In embodiments, extension block 3405 can be releasably fastened to any of the blocks 3205-1, 3205-2, 3205-3 to extend the height of the blocks. In embodiments, the protrusions 3415 on the extension block 3405 extend into openings 3225 in the blocks 3205-1, 3205-2, 3205-3 in substantially the same manner as discussed above with respect to the protrusion 415 and the openings 225 discussed above. In embodiments, the height of the extension block 3405 may have different heights depending on application. In embodiments, the extension block 3405 extends the height of the blocks 3205-1, 3205-2, 3205-3. In embodiments, the fasteners 430 may be provided on both sides of the blocks 3205-1, 3205-2, 3205-3 and may be positioned at about ⅓ and ⅔ of the total length of the blocks 3205-1, 3205-2, 3205-3. In embodiments, two pairs of fastener elements may be provided on the sidewall 3230 of the blocks 3205-1, 3205-2, 3205-3. In embodiments, the number and positions of the fasteners may be varied.

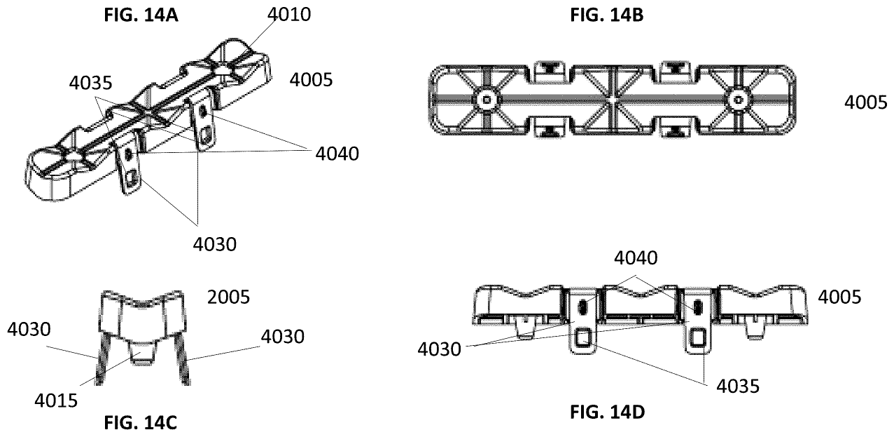

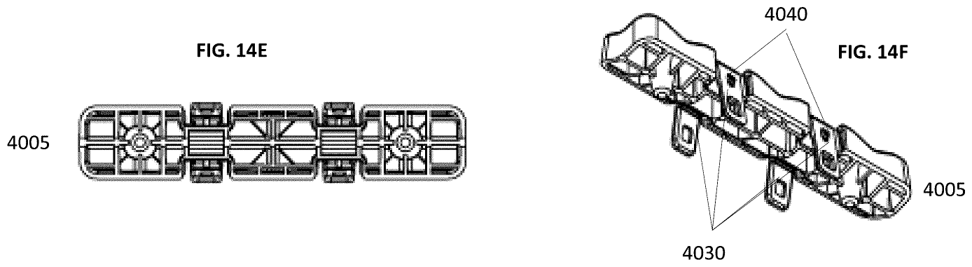

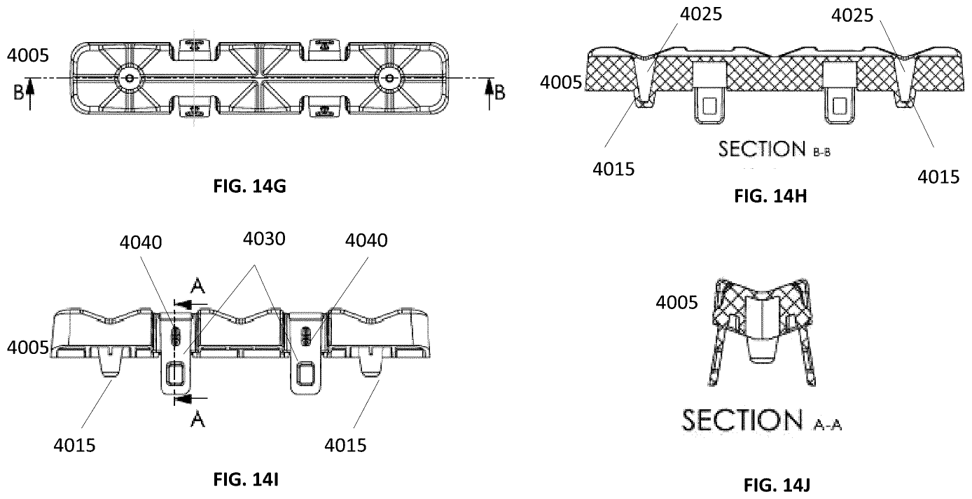

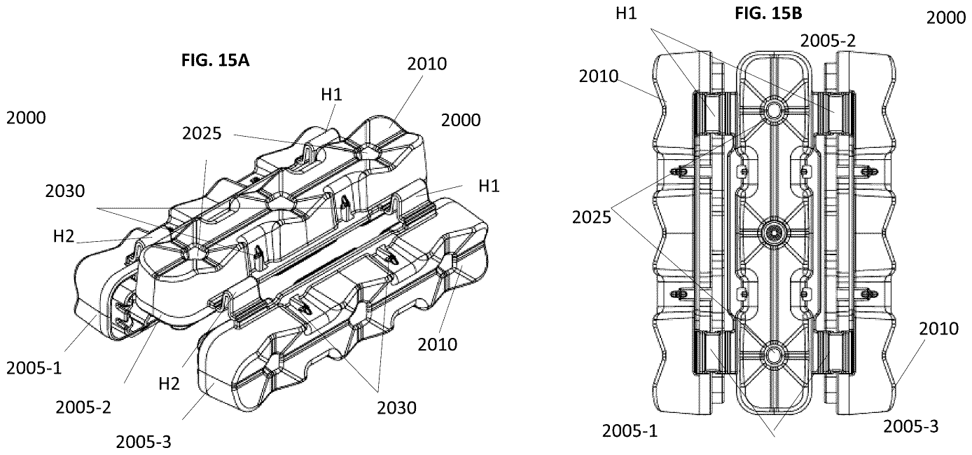

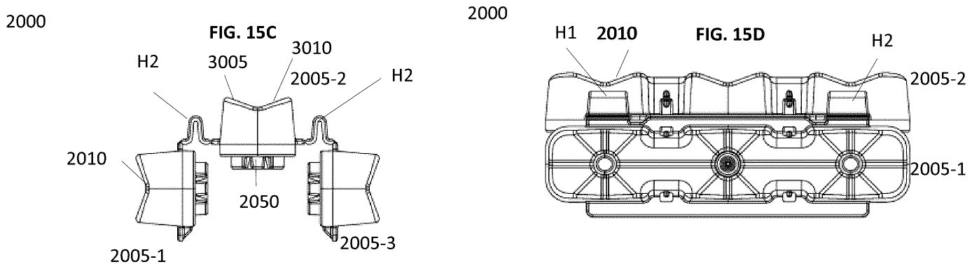

FIG. 14A illustrates an exemplary view of an extension block 4005. In embodiments, FIG. 14B is a top view thereof while FIG. 14C is an end view thereof. FIG. 14D is a side view of the extension block 4005. FIG. 14E is a bottom view of the extension block 4005 while FIG. 4F is a bottom perspective view. The extension block 4005 may be similar to the block 405 discussed above. In embodiments, the downward extensions 4015 extend from the extension block 4005 into the openings 2025 in the top of the block 2005 (See FIG. 15, for example) on which they are positioned. In embodiments, block 2005 may include additional or fewer top openings 2025 for fittingly coupling with extension block 4005 via a corresponding number of extensions 4015 on extension block 4005.

In embodiments, the extension block 4005 is adapted to be fittingly coupled to a top side of support block 2005 discussed below. In embodiments, extension block 4005 may be made of the same material as support block 2005.

In embodiments, as can be seen in FIG. 14A extension block 4005 incorporates a top support surface 4010 that is substantially the same, in size, shape, and/or contours, as top support surface 2010 of each support block 2005 discussed below, including top openings 4025 (FIG. 14H) that correspond to top openings 2025. As shown in FIG. 14C, in embodiments, extension block 4005 incorporates two extensions 4015 (FIG. 14I) that correspond, in size and shape, to top openings 2025 on top support surface 2010 of blocks 2005. Extension block 4005 further incorporates contours around extensions 4015 that correspond to the contours of top surface 2010 of support blocks 2005 (or top support surface 4010 of another extension block 4005) so that extension block 4005 is fitted atop top support surface 2010 of support block 2005 (or another extension block 4005) when bottom side extensions 4015 are at least partially inserted into top side openings 2025 (or top side openings 4025). Friction between the side walls of bottom side extensions 4015 and the interior walls of top side openings 2025 holds extension block 4005 to support block 2005. In certain embodiments, releasable mating notches, ridges, rims, or the like, can be incorporated to the interior of top side openings 2025 and bottom side extensions 4015 for a releasable engagement that holds blocks 2005 and 4005 together.

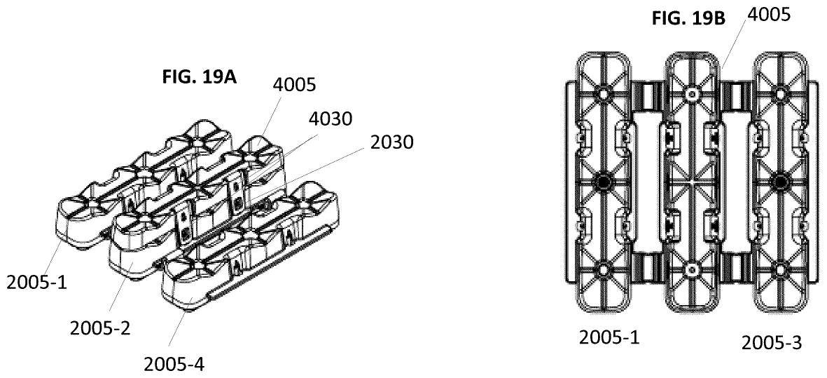

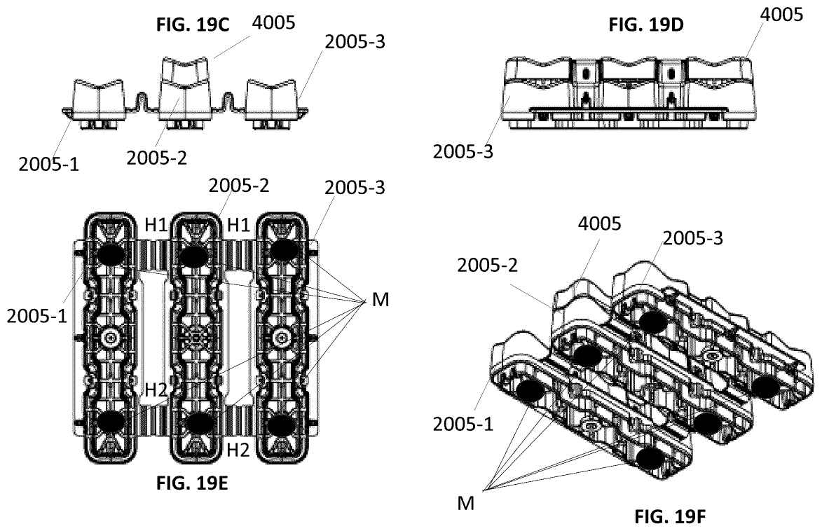

Each block 4005 may include fasteners 4030 that are adapted to engage corresponding fastener elements 2030 on blocks 2005, which are shown in FIG. 15A, for example. According to one or more exemplary embodiments, fasteners 4030 are resilient (e.g., rubber) tabs that incorporate openings 4035 for hooking onto fastener elements 2030 that are in the form of angled protrusions, or anchors, on respective side walls on opposing sides of blocks 2005. Thus, extension block 4005 can be releasably fastened to block 2005 when the height (h₂) of block 2005 needs to be extended for supporting a pipe P. FIG. 19 illustrates extension block 4005 fastened to block 2005-2 of support block assembly 2000. Extension block 4005 can be formed to have any height, including up to the height (h₂) of block 2005. According to one or more exemplary embodiments, extension block 4005 extends the height (h₂) of block 2005. According to one or more exemplary embodiments of the present disclosure, fastener elements 2030 and fasteners 4030 are disposed on both sides of blocks 2005 and block 4005, respectively, at positions that are about ⅓ and ⅔ of the total lengths from the ends of blocks 2005 and 4005. Thus, as illustrated in the figures, blocks 2005 and 4005 each incorporate two pairs of fastener elements 2030 and fasteners 4030, respectively, that are disposed at positions that divide the length of the block 2005 or 4005 into thirds.

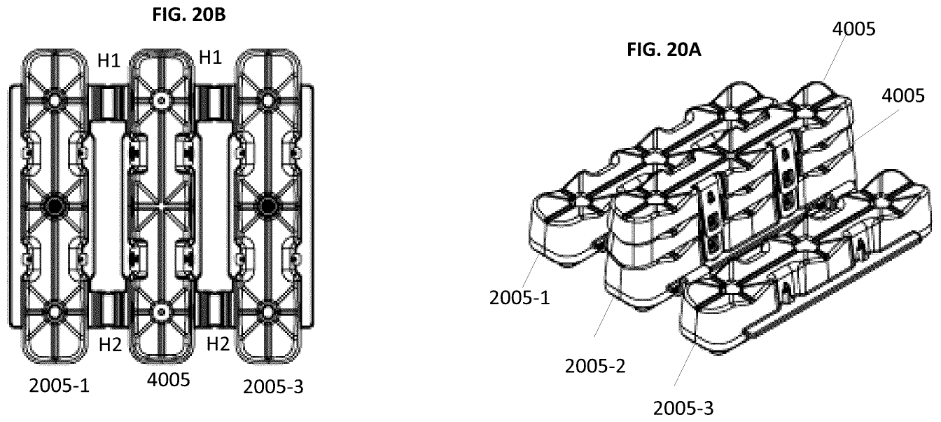

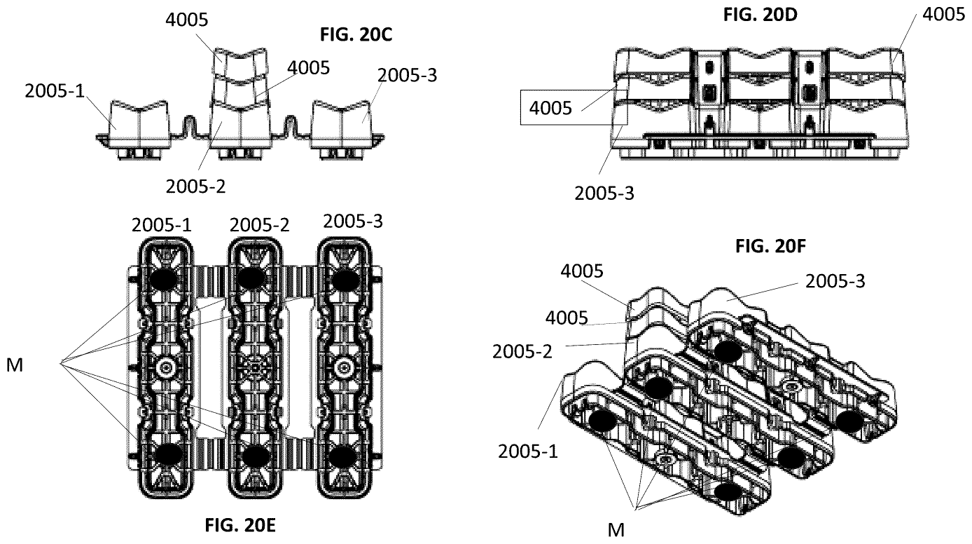

As further illustrated in FIGS. 14A and 14B, extension block 4005 incorporates fastener elements 4040, such as angled protrusions or anchors, that are positioned to allow for fasteners 4030 of a second extension block 4005 to be fastened atop a first extension block 4005 as can be seen in FIGS. 20-22. In other words, more than one extension block 4005 can be stacked atop a support block 2005 by fastening fasteners 4030 of a first extension block 4005 to fastener elements 2030 of a support block, fastening fasteners 4030 of a second extension block 4005 to fastener elements 4040 of the first extension block 4005, and so on. Thus, blocks 2005 and/or assembly 2000, with extension blocks 4005, provide flexibility for supporting pipes of various diameters and corresponding insulation of various thicknesses. The uniformity of blocks 2005 provides for reduced manufacturing costs, while different numbers of extension blocks 4005 can be used to provide flexibility for fittingly supporting pipes of various sizes and with insulation of various thicknesses. According to one or more exemplary embodiments of the present disclosure, extension block 4005 extends the height (h₂) of top support surface 2010 of support blocks 2005 so that a total height to a corresponding peak (not shown) on top support surface 4010 from bottom side 2015 of support block 2005 is set as desired. In certain embodiments, extension blocks 4005 may be provided with different heights for different height adjustments.

FIG. 14C illustrates an end view of the extension block 4005 and FIG. 14D illustrates a side view thereof. FIG. 14E is a bottom view of the extension block 4005 and FIG. 4F illustrates a bottom perspective view. FIG. 14 G is a top view of block 2005 showing line B-B while FIG. 14H illustrates a cross-section along line B-B. FIG. 14I is a side view of the block 4005 showing line A-A and FIG, 14J is a cross-section of the line A-A.

FIG. 15A illustrates a top perspective view of a support block assembly 2000 in accordance with an embodiment of the present disclosure. FIG. 15B is a top view of the support block assembly 2000 and FIG. 15C is an end view of the support block assembly 2000 and FIG. 15D is a side view of the support block assembly 2000. In accordance with one or more exemplary embodiments, the support block assembly 2000 may be made of a rigid or semi-rigid material, such as a polymer composite, fiber glass, or the like similar to the block 205 discussed above that is adapted to provide a secure support structure for holding up a pipe. In embodiments, any suitable rigid or semi-rigid material may be used in the support block assembly 2000. In embodiments, the assembly 2000 includes three support blocks 2005-1, 2005-2, 2005-3 connected to each other via respective pairs of spaced living hinges H1, H2 positioned at opposite ends thereof.

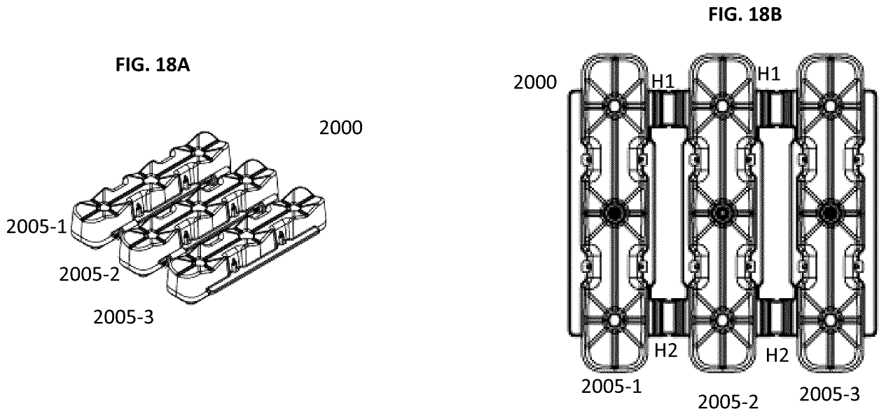

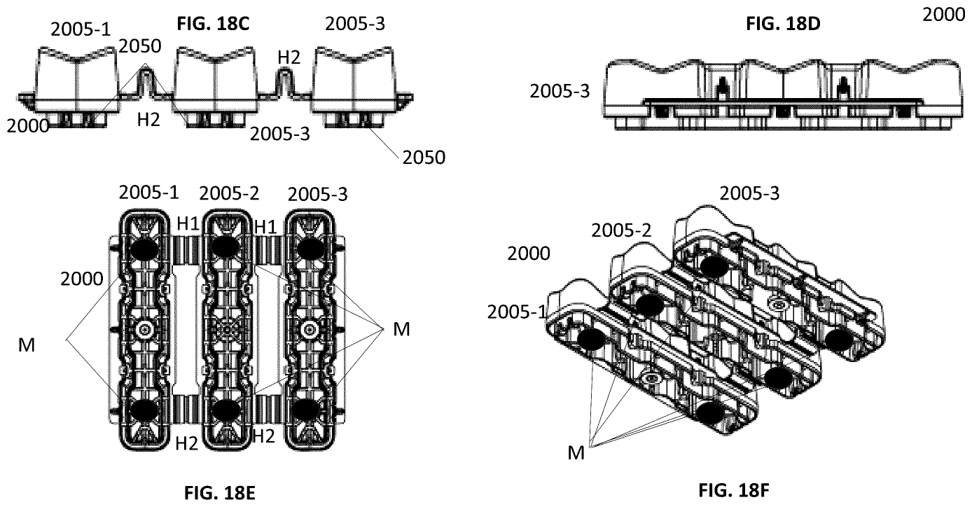

Each support block 2005 includes a top support surface 2010 that is smaller than a bottom portion 2015 across one or both dimensions of block 2005. Advantageously, in embodiments, the larger bottom 2015 of each block 2005 contributes to its stability during deployment so that block 2005 does not easily rotate onto its side when, for example, it is placed between a pipe P and a horizontal member H, or support plate. In embodiments, each block 2005 is identical in shape and dimension. In embodiments, one or more blocks 2005 may have different dimensions—for example, one block 2005-1 may be slightly larger than side blocks 2005-2 and 2005-3, or vice versa as can be seen in the grouping of blocks 2000, shown in FIG. 15A, for example. In embodiments, a magnet M may be positioned in a bottom 2015 of each block such as indicated in FIGS. 18E and 18F. In embodiments, the magnet M of each block 2005 may secure the assembly 2000 in place during use.

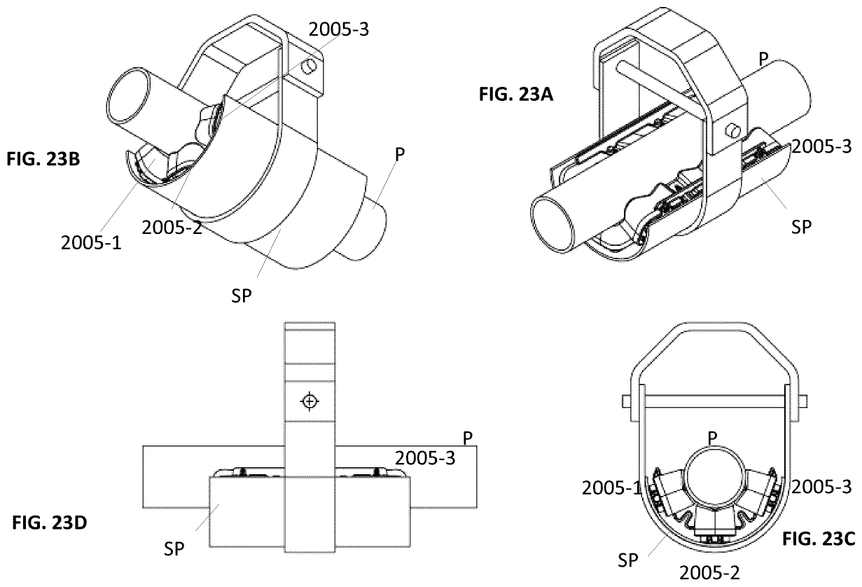

In embodiments, the top support surface 2010 incorporates one or more concave elements that are adapted to contact and corresponding one or more sections of a cylindrical outer surface of one or more pipes (e.g., pipe P) as can be seen in FIGS. 23A-23D , for example.

Each block 2005 may include incurvations on the top support surface 2010 along the lengths thereof as can be seen in FIG. 15D for example. As shown in FIG. 15C, the lengthwise incurvation on the top surface 2010 of each block 2005 is formed by two opposing angled surfaces 3005 and 3010 that extend along the length of block 2005 and provide a V shaped recess. In embodiments, each the angled surfaces 3005 and 3010 is angled with respect to horizontal (like the angles θ₁ and θ₂ in FIG. 3A) such that a V shape with a height (h₁) is formed between the side peaks and the center bottom of the V shape, thereby approximating an arc that corresponds to an exterior surface of a pipe P. In embodiments, the angles of the surfaces may vary and the height h₁ provided that a suitable V shape is provided. In the blocks 2005, just as in FIG. 3A, each block 2005 incorporates a top support surface 2010 with a peak-to-peak width (w₁) in the V shape, which defines an approximate contact width of top support surface 2010 on the pipe P. The width w₁ may also vary provided that a desired V shape is provided. Accordingly, in embodiments, the angled surfaces 3005 and 3010 form V-shaped troughs along the lengths of blocks 205. As noted above. the angled surfaces may form other shaped troughs to support pipe P, such as U-shaped, for example. Any suitable shape that supports the pipe P and holds it in place may be used. In embodiments, the angled surfaces 3005 and 3010 are adapted to contact a cylindrical pipe, such as the pipe P in FIGS. 24A-24D, from respective sides to provide support. In embodiments, the angled surfaces 3005 and 3010 restrict roll and slide movements between the pipe and blocks 2005. Advantageously, in embodiments, the block assembly 2000 provides a stable interface between a top surface 2010 and the pipe P. In embodiments, the symmetrical angled surfaces 3005 and 3010 (e.g., having substantially the same widths and equal angles θ₁ and θ₂) but surfaces 3005 and 3010 may have different angles from horizontal and/or different widths across the block 2005 to form the asymmetrical top support surface 2010. In embodiments, the support block 2005 may also incorporate different depth-to-width ratios, for example, h₁-w₁ ratios, for supporting different pipes.

In embodiments, each support block 2005 may have a height (h₂) of about 2.5 cm. In embodiments the height (h₂) may be varied to accommodate the thickness of insulation that is to be applied to a pipe P. In embodiments, a desired ratio between the height of the incurvation (h₁) on the top support surface 2010 to the overall height of block 2005 (h₂) may be maintained. In certain embodiments, the height (h₂) may be made larger or smaller based on the insulation to be installed to a pipe and, correspondingly, the h₁:h₂ ratio can be made larger or smaller.

In embodiments, each support block 2005 incorporates tapered side walls so that the bottom 2015 is larger than the upper support surface 2010 as noted above. Each block 2005, therefore, has a wider base than top side. Each block 2005 incorporates a top support surface 2010 with a peak-to-peak width (w₁) (like that shown in FIG. 3A), which defines an approximate contact width of the top support surface 2010 on the pipe. The bottom side width (w₂) of the bottom side 2015 may have a desired value as well. In embodiments, top support surface 2010 is a first length and the bottom side 2015 has a second length. The larger bottom side 2015 of each block 2005 contributes to its stability during deployment so that block 2005 does not easily rotate when, for example, it is placed between a pipe (P) and a horizontal member (H) as illustrated in FIG. 1. In embodiments, the top surface 2010 include depressions such that transvers slots are provided as cab be seen in the side view 15D.

In embodiments, each support the block 2005 includes top opening 2025 provided in the top surface 2010. Each support block 2005 incorporates a pair of top openings 2025 formed in the top surface 2010 at respective ends thereof. In embodiments, the top openings 2025 are sized and positioned for connection with an extension block. As noted above, the openings 2025 received the extensions 4015 of the extension blocks 4005 to allow stacking of the extension blocks.

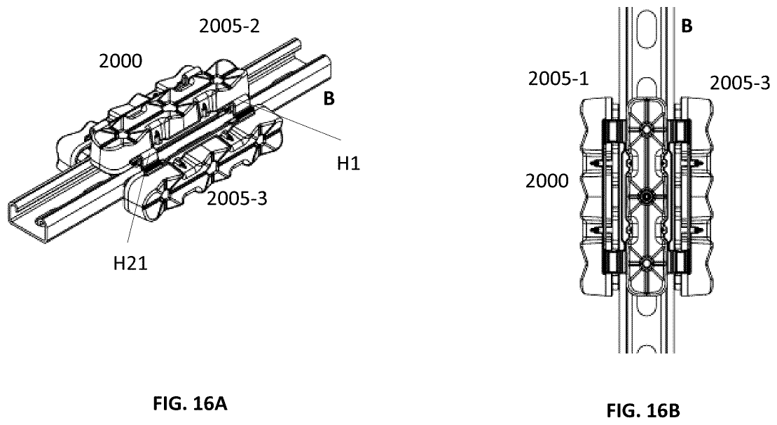

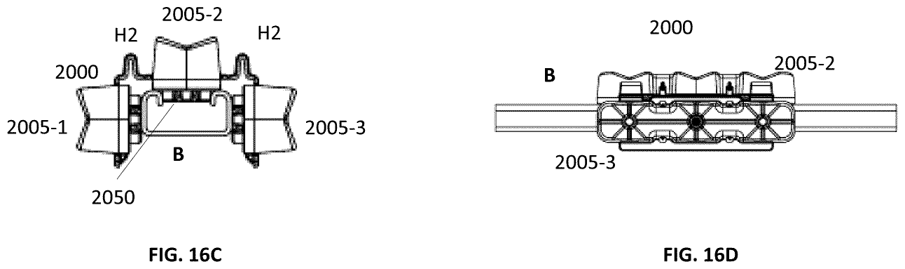

FIG. 16A illustrates the support block assembly 2000 of FIG. 16 mounted in a C-channel bracket B. In embodiments, the support blocks 2005 wrap around a top of the bracket. FIG. 16A illustrates a perspective view of the assembly 2000 in the C-channel bracket B, while FIG. 16B illustrates a top view thereof. FIG. 16C shows an end view of the assembly 2000 mounted on bracket B and FIG. 16D shows a side view thereof. As indicated in FIG. 16C, a bottom protrusion 2050 extends downward from the block 2005-2 and is engaged by the C channel of the bracket B.

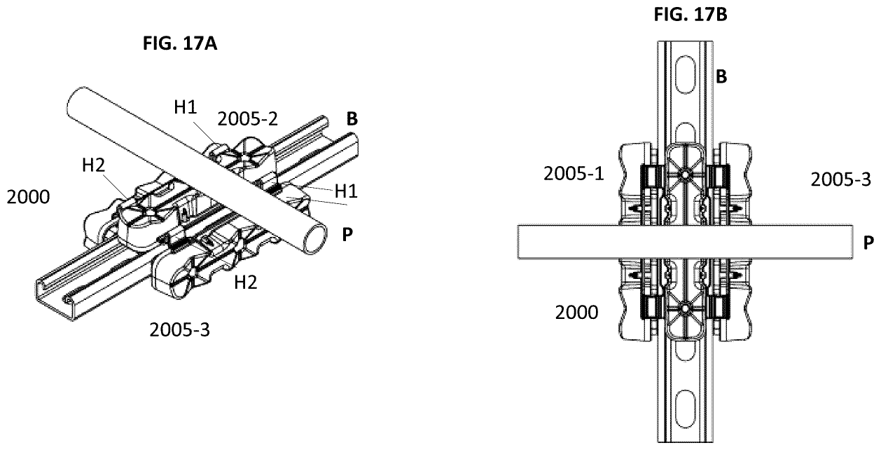

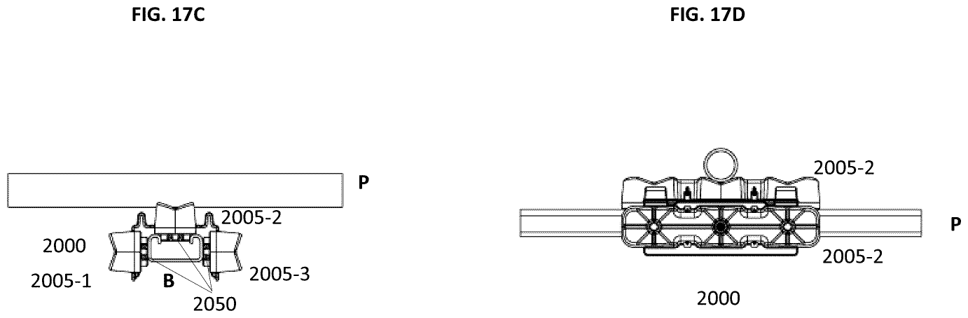

FIG. 17A illustrates a pipe P supported transversely across the block 2005-2. The pipe P is illustrated as being supported by a central portion of the blocks 2005-1, 2005-2 and 2005-3, however, may be positioned elsewhere. The support surface 2010 of the blocks 2005-1, 2005-2 and 2005-3 includes depressions forming a V in the transverse direction to support the pipe P as can be seen in the side view of FIG. 17D. FIG. 17B illustrates a top view thereof. FIG. 17C shows an end view of the assembly 2000 supporting transverse pipe P and FIG. 17D shows a side view thereof.

FIG. 18A illustrated the assembly 2000 with the blocks 2005-1, 2005-2, 2005-3 in an unflexed states where the hinges H1, H2 are not flexed. FIG. 18B illustrates a top view thereof. FIG. 18C shows an end view of the assembly 2000 and FIG. 18D shows a side view thereof while FIG. 18E is a bottom view and FIG. 18F is a bottom perspective view. In embodiments, each of the blocks 2005-1, 2005-2, 2005-3 may include one or more magnets M mounted on a bottom thereof as illustrated in FIG. 18E. The magnets M may be used to secure the assembly 2000 during use.

FIG. 19A illustrates a perspective view of the assembly 2000 with an extension block 4005 mounted on the support block 2005-2. FIG. 19B illustrates a top view thereof. FIG. 19C shows an end view of the assembly 2000 and FIG. 19D shows a side view thereof. FIG. 19E is a bottom view thereof and FIG. 19F illustrates a bottom perspective view thereof. In embodiments, the magnet M may be used to secure the assembly 2000 in place during use.

FIG. 20A illustrates the assembly 2000 with two extension blocks mounted on the support block 2005-2. FIG. 20B illustrates a top view thereof. FIG. 20C shows an end view of the assembly 2000 and FIG. 20D shows a side view thereof. FIG. 20E is a bottom view thereof and FIG. 20F illustrates a bottom perspective view thereof.

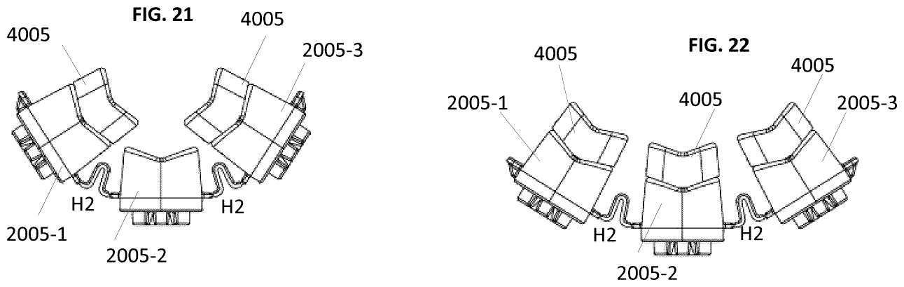

FIG. 21 illustrates an end view of the assembly 2000 including an extension block 4005 mounted on support block 2005-1 and a second extension block 4005 mounted on the support block 2005-3. FIG. 22 illustrated an end view of the assembly 2000 including an extension block 4005 mounted on support block 2005-1, a second extension block 4005 mounted on the support block 2005-2 and a third extension block 4005 mounted on support block 2005-3.

FIG. 23A illustrates a top perspective view of the assembly 2000 mounted on a support plate SP for supporting pipe P. FIG. 23B illustrates a bottom perspective view thereof. FIG. 23C shows an end view of the assembly 2000 and FIG. 23D shows a side view thereof.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting.

While the disclosure has described several example implementations, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for carrying out this disclosure, but that the disclosure will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope encompassed by the present disclosure, which is defined by the set of recitations in the following claims and by structures and functions or steps which are equivalent to these recitations.

What is claimed is:

1. A support block for supporting a pipe comprising:
an elongated base;
a top surface including depressions extending longitudinally and transversely and having a first width;
a bottom portion having a second width, the second width larger than the first width; and
the base made of a flexible material.

2. The support block of claim 1, further comprising at least one opening formed in a top surface configured to receive a portion of an extension block configured for mounting on the support block.

3. The support block of claim 1, further comprising a pair of openings formed on a top surface configured to receive portions of an extension block configured for mounting on the support block.

4. The support block of claim 1, further comprising a fastening element positioned on a sidewall of the elongated base and configured to interact with an extension block configured for mounting on the support block.

5. The support block of claim 1, further comprising at least one hinge connected to a sidewall of the base, wherein the at least one hinge is connectable to a second support block such that the second support block is rotatable relative to the support block.

6. The support block of claim 5, wherein the at least one hinge is a living hinge.

7. The support block of claim 5, wherein the at least one hinge is a first hinge of a pair of hinges connecting the support block to the second support block.

8. The support block of claim 1, further comprising a first hinge connected to a first sidewall of the base, wherein the first hinge is connectable to a second support block such that the second support block is rotatable relative to the support block and a second hinge connected to a second sidewall of the base, wherein the second hinge is connectable to a third support block such that the third support block is rotatable relative to the support block.

9. The support block of claim 8, wherein the first hinge is a living hinge and the second hinge is a living hinge.

10. The support block of claim 8, wherein the first hinge is one of a pair of hinges connecting the support block to the second support block and the second hinge is one of a second pair of hingers connecting the support block to the third support block.

11. A support block assembly configured to support a pipe, the support block assembly comprising:
a first support block rotatably connected to a second support block and a third support block rotatably connected to the second support block,
wherein each of the first support block, the second support block and the third support block includes:
an elongated base;
a top surface including respective depressions extending longitudinally and transversely;
a top surface having a first width;
a bottom portion having a second width, the second width larger than the first width; and
the base made of a flexible material.

12. The support block assembly of claim 11, further comprising an extension block configured for mounting on one of the first support block, the second support block and the third support block.

13. The support block assembly of claim 12, wherein the extension block comprises at least one protrusion extending from a bottom portion thereof and configured to interact with at least one of the first support block, the second support block and the third support block.

14. The support block assembly of claim 13, wherein each of the first support block, the second support block and the third support block includes at least one opening formed in a top surface thereof and configured to receive the at least one protrusion of the extension block.

15. The support block assembly of claim 13, wherein the extension block includes a fastener extending from a sidewall of the extension block and below a bottom portion thereof to contact one of the support block, the second support block and the third support block to secure the extension block to a respective one of the support block, the second support block and the third support block.

16. The support block assembly of claim 15, where each of the support block, the second support block and the third support block includes a fastener element positioned on a sidewall thereof to interact with the fastener of the extension block to secure the extension block to one of the support block, the second support block and the third support block.

17. The support block assembly of claim 11, wherein the support block is secured to the second support block via a first hinge such that the second support block is rotatable relative to the support block and the support block is secured to the third support block via a second hinge such that the third support block is rotatable relative to the support block.

18. The support block assembly of claim 17, wherein the first hinge and the second hinge are living hinges.

19. The support block assembly of claim 17, wherein the first hinge is one of a first pair of hinges and the second hinge is one of a second pair of hinges.

20. The support block assembly of claim 11, wherein the support block, the second support block and the third support block each include a pair of notches formed at a bottom edge thereof to aid in flexing of the base.
